(19) United States
(12) Patent Application Publication
(10) Pub. No.: US 2012/0318080 A1
(43) Pub. Date: Dec. 20, 2012

(54) TORQUE MULTIPLIER

(75) Inventor: Tuan Vinh Le, Mississauga (CA)

(73) Assignee: L.T. Machine & Tools Inc., Mississauga (CA)

(21) Appl. No.: 13/574,776

(22) PCT Filed: Jan. 24, 2011
(86) PCT No.: PCT/CA2011/000076

§ 371 Date: Jul. 23, 2012

(30) Foreign Application Priority Data
Jan. 25, 2010 (CA) 2690970
Aug. 18, 2010 (CA) 2713454
Jan. 13, 2011 (CA) 2728260

(51) Int. Cl. F16H 21/14

(52) U.S. Cl. 74/68

(57) ABSTRACT

A torque multiplier for converting an input torque to an output torque. A torque multiplier includes a cam mounted on a drive shaft for rotation therewith when an input torque is applied to the drive shaft, the cam providing a magnetic field that is radially asymmetrical relative to the drive shaft, a first output shaft for providing an output torque, and a magnet spaced apart from the cam and mounted to move relative to the cam in response to magnetic coupling forces between the cam and the magnet as the cam rotates, the magnet being operatively connected to drive the first output shaft, wherein magnetic coupling forces between the cam and the magnet return rotational energy to the drive shaft during part of the cam rotation.

This application claims priority to and the benefit of Canadian Patent Application No. 2,690,970, filed Jan. 25, 2010, and Canadian Patent Application No. 2,713,454, filed Aug. 18, 2010, the subject matter of both applications being incorporated herein by reference.

### BACKGROUND

This disclosure relates to devices for translating an input torque to an output torque.

Gearboxes and other devices for transmitting power from a driving force to a desired output force are commonly used. The output torque or force may be higher or lower than the input torque or force, but in any event, the output power is often substantially lower than the input power as a result of frictional forces within the power transmitting device, which often is undesirable.

### SUMMARY

According to an example embodiment is a torque multiplier for converting an input torque to an output torque. The torque multiplier includes a cam mounted on a drive shaft for rotation therewith when an input torque is applied to the drive shaft, the cam providing a magnetic field that is radially asymmetrical relative to the drive shaft, a first output shaft for providing an output torque, and a magnet spaced apart from the cam and mounted to move relative to the cam in response to magnetic coupling forces between the cam and the magnet as the cam rotates, the magnet being operatively connected to drive the first output shaft, wherein magnetic coupling forces between the cam and the magnet return rotational energy to the drive shaft during part of the cam rotation.

According to one example embodiment is a torque multiplier for multiplying an input torque to a larger output torque. The torque multiplier includes a first magnetic cam rotatable about a first axis and providing a magnetic field that is radially asymmetrical relative to the first axis, a first output shaft, and a first lever biased into a first position and bearing a first magnet spaced apart from the first magnetic cam, the first lever being operatively connected to rotationally drive the first output shaft, wherein magnetic coupling between the first magnetic cam and the first magnet causes the first lever to pivot from the first position to a second position during rotation of the first magnetic cam.

According to another example embodiment is a torque multiplier for multiplying an input torque to a larger output torque, the torque multiplier including a frame, an input drive assembly including a drive shaft rotatably mounted to the frame and a magnetic cam mounted for rotation with the drive shaft, the magnetic cam providing a magnetic field that varies in strength around a circumference of the drive shaft to provide a strong magnetic field portion and a weaker magnetic field portion, and a first output shaft rotatably mounted to the frame. A first lever is mounted to the frame for movement between a resting position and an activated position, the first lever bearing a first magnet at one end thereof and connected at an opposite end thereof by a mechanical linkage to rotationally drive the first output shaft when the first lever is moved from the resting position to the activated position, the magnet bearing end of the first lever being located adjacent the magnetic cam such that repulsive magnetic forces between the magnetic cam and the first magnet cause the first lever to pivot from the resting position to the activated position when the strong magnetic field portion of the magnetic cam rotates by the first magnet, the first lever being biased to return to the resting position after the strong magnetic field portion rotates by the first magnet.

According to an example is a torque multiplier for multiplying an input torque to a larger output torque, the torque multiplier including: a frame; an input drive assembly including a drive shaft rotatably mounted to the frame and a magnetic cam mounted for rotation with the drive shaft, the magnetic cam providing a magnetic field that varies in strength about a circumference of the drive shaft; a first output shaft rotatably mounted to the frame; and a first lever mounted to the frame for pivoting between a resting position and an activated position, the first lever bearing a first magnet pivotally mounted at one end of the first lever for pivoting between a first magnet position and a second magnet position wherein the first magnet pivots in the same rotational direction as the magnetic cam when pivoting from the first magnet position to the second magnet position, the first lever connected at an opposite end thereof by a mechanical linkage to rotationally drive the first output shaft when the first lever is moved from the resting position to the activated position, the magnet bearing end of the first lever being located adjacent the magnetic cam, the first lever being normally biased into the resting position. During rotation of the magnetic cam there is a duration when repulsive magnetic forces between the magnetic cam and the first magnet cause the first lever to pivot from the resting position to the activated position and the first magnet to pivot from the first magnet position to the second magnet position, a subsequent duration when repulsive magnetic forces between the magnetic cam and the first magnet cause the first magnet to pivot from the second magnet position back to the first magnet position while the first lever remains in the activated position, and a further subsequent duration when the first lever returns to the resting position.

According to an example there is provided a torque multiplier for converting an input torque to a larger output torque, comprising a drive shaft having a cam mounted thereon, the cam providing a magnetic field that is radially asymmetrical relative to the drive shaft; a first output shaft for providing an output torque; and a first lever mounted to pivot between a first position and a second position and bearing a lever-mounted magnet spaced apart from the cam, the first lever being operatively connected to rotationally drive the first output shaft, wherein magnetic coupling between the cam and the lever-mounted magnet during each rotation of the cam causes the first lever to pivot and rotational energy to subsequently be returned to the drive shaft.

According to an example embodiment is a torque multiplier for multiplying an input torque to a larger output torque, including: a frame; an input drive assembly including a drive shaft rotatably mounted to the frame and a magnetic cam mounted for rotation with the drive shaft, the magnetic cam providing a magnetic field that varies in strength around a circumference of the drive shaft; a first output shaft rotatably mounted to the frame; and a magnet mounted to the frame for movement between a resting position and an activated position, the magnet being connected by a mechanical linkage to rotationally drive the first output shaft when the magnet is moved from the resting position to the activated position, the magnet being located adjacent the magnetic cam such that repulsive magnetic forces between the magnetic cam and the magnet cause the magnet to move from the resting position to the activated position and subsequently return to the resting position during rotation of the cam.

### BRIEF DESCRIPTION OF FIGURES

Example embodiments are described herein with reference to the following figures:

FIG. 1 is a schematic perspective view of a torque multiplier according to an example embodiment;

FIG. 2 is a front elevation of the torque multiplier of FIG. 1;

FIG. 3 is a right side elevation of the torque multiplier of FIG. 1;

FIG. 4 is a schematic side view of a power generator of the torque multiplier of FIG. 1, in a first pivot position;

FIG. 4A is a schematic side view of a power generator of the torque multiplier of FIG. 1, in a further position;

FIG. 5 is a schematic side view of the power generator of FIG. 4 in a second pivot position;

FIG. 6 is a schematic side view of the power generator of FIG. 4 in a third position;

FIG. 7 is a schematic side view of the power generator of FIG. 4 in a fourth position;

FIG. 8 is a partial schematic side view of the power generator of FIG. 4 showing a first, horizontally oriented, set of pivoting drive levers;

FIG. 9 is a partial schematic side view of the power generator of FIG. 4 showing a second, vertically oriented, set of pivoting drive levers;

FIG. 10 is a perspective view of an input drive assembly of the torque multiplier of FIG. 1;

FIG. 11A is a schematic back view of the input drive assembly of FIG. 10;

FIG. 11B is a schematic plan view of the input drive assembly of FIG. 10;

FIG. 12 is a perspective view of a magnetic cam of the input drive assembly of FIG. 10;

FIG. 13 is a side view of the magnetic cam of FIG. 12;

FIGS. 13A, 13B and 13C are partial side views of the magnetic cam passing by a lever mounted magnet in the torque multiplier of FIG. 1;

FIG. 14A is a schematic back view of a first output drive assembly of the torque multiplier of FIG. 1;

FIG. 14B is a schematic back view of a second first output drive assembly of the torque multiplier of FIG. 1;

FIGS. 15 and 16 are perspective views of alternative embodiments of an input drive assembly;

FIGS. 17A and 17B are a schematic back view and a schematic plan view, respectively, of a further example of an input drive assembly;

FIG. 18 is a plan view of a further alternative embodiment of an input drive assembly; and

FIG. 19 is a diagrammatic partial view of a further example of a torque multiplier.

The same reference numerals may be used throughout the drawings to refer to similar components.

### DETAILED DESCRIPTION

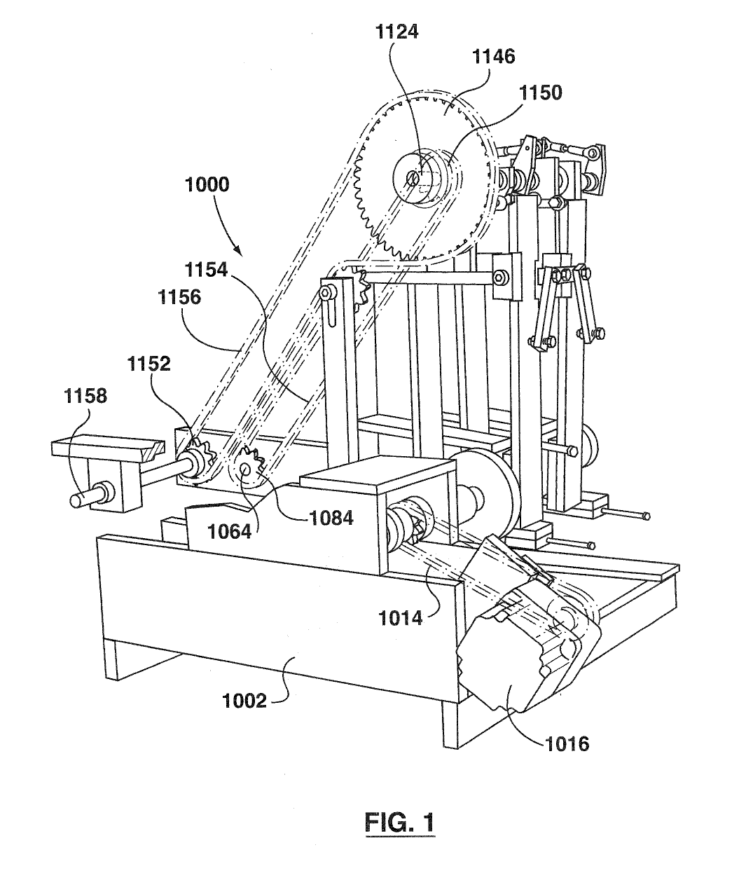

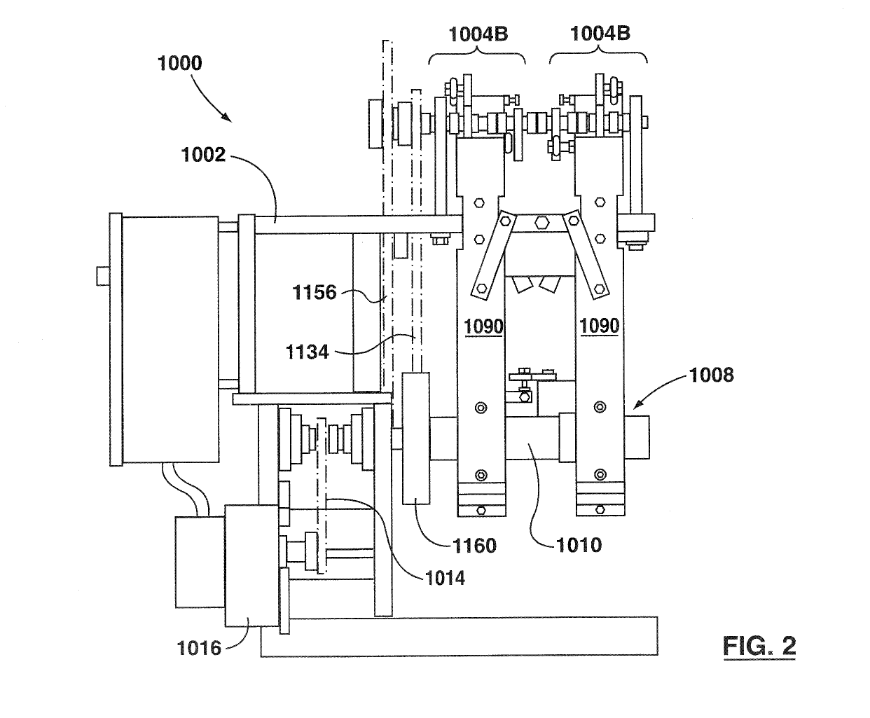

FIGS. 1 to 3 illustrate a torque multiplier 1000 according to example embodiments. The torque multiplier 1000 includes a rigid housing or frame 1002 for supporting the components of the torque multiplier 1000. In an example embodiment, the torque multiplier 1000 includes two side-by-side power generator assemblies 1004A and 1004B (see FIG. 2) that are substantially identical to each other. The power generator assemblies 1004A and 1004B will be generically referenced using reference numeral 1004 when features common to both power generator assemblies are discussed herein. As will be explained in greater detail below each of the power generator assemblies 1004A, 1004B has an associated magnetic cylinder or cam 1006A, 1006B (generically referred to using reference number 1006 when features common to both cams 1006A and 1006B are discussed herein) that is used for magnetically activating respective sets of magnetic drive members to drive output shafts.

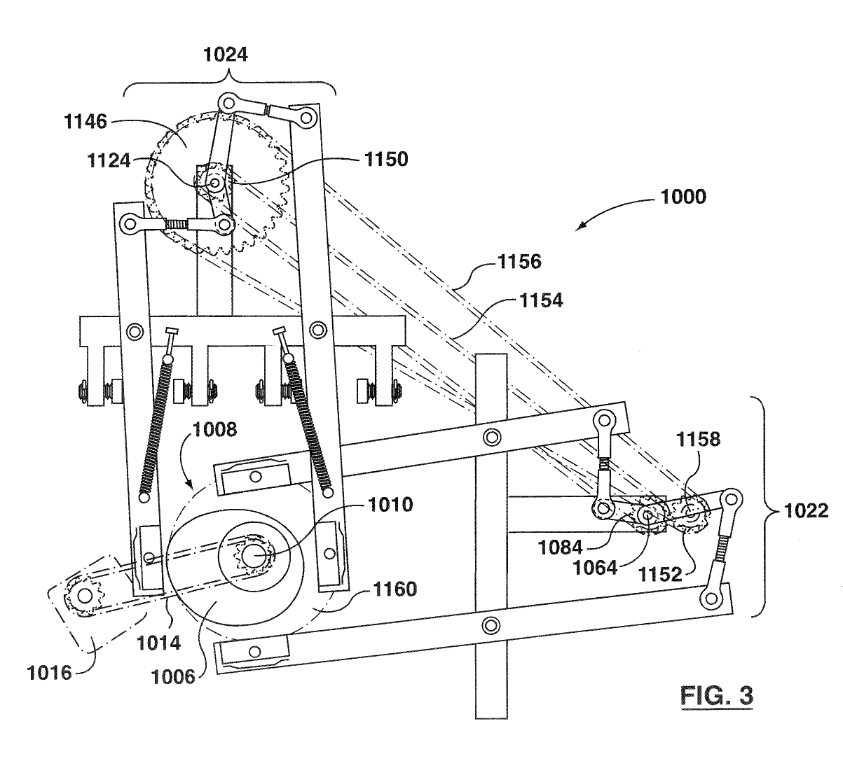

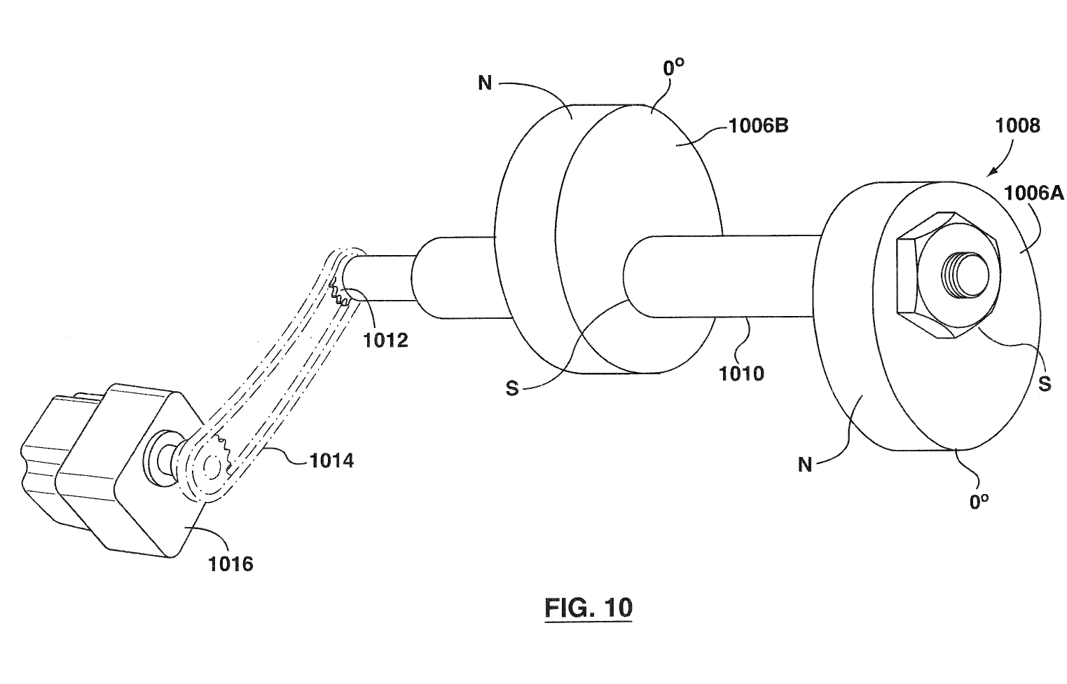

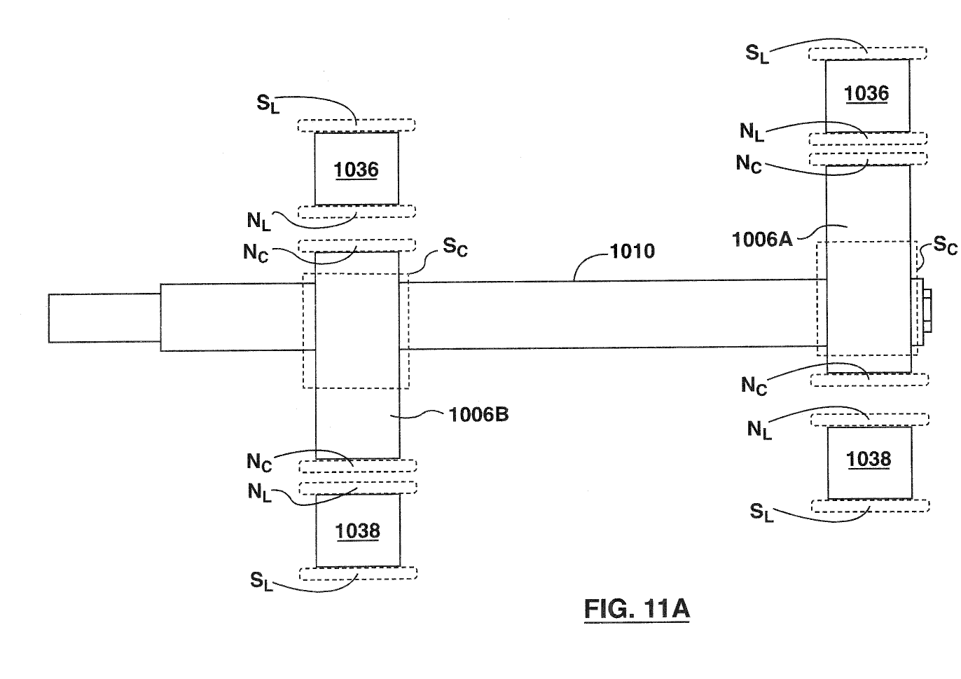

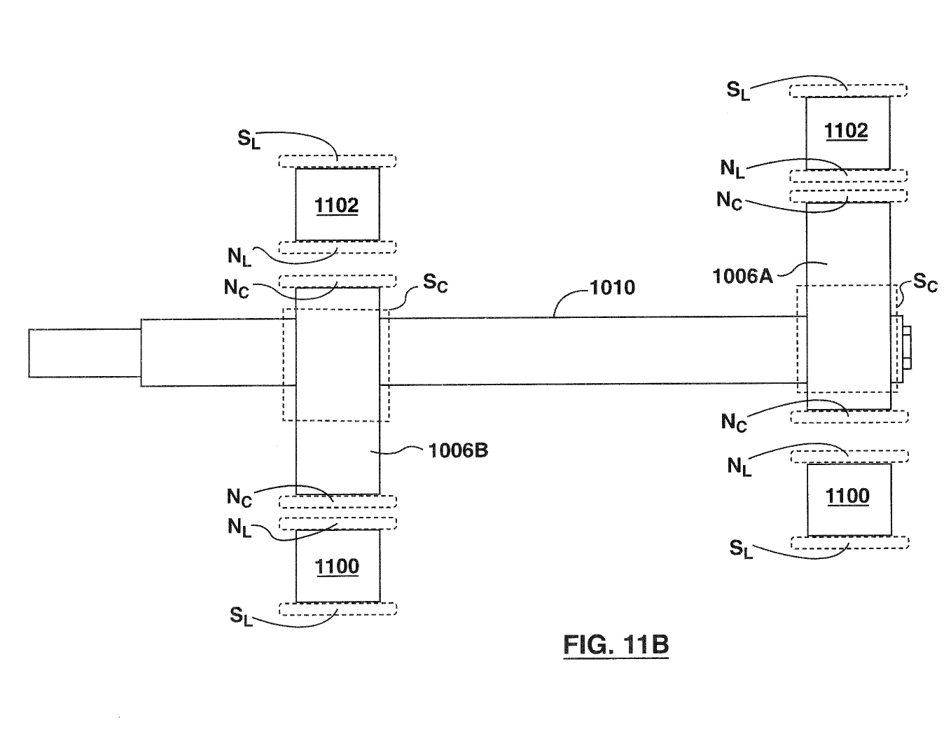

Referring to FIGS. 10, 11A and 11B, in an example embodiment the magnetic cams 1006A and 1006B are part of an input drive assembly 1008 that includes a drive shaft 1010 on which the magnetic cams 1006A and 1006B are mounted in spaced apart fashion. A flywheel 1160 (see FIG. 2 and FIG. 3) may be mounted in the drive shaft 1010 in some examples. The drive shaft 1010 can for example be rotatably mounted to frame 1002 by swivel bearings and may include a drive sprocket 1012 that is connected by a drive chain 1014 to a driving force such as a drive motor 1016. In example embodiments the drive motor 1016 is a variable speed control electrical motor however other power sources can be used such as a combustion engine, among other things. Additionally, different drive configurations other than a drive chain can alternatively be used to apply a rotational driving force to the drive shaft 1010.

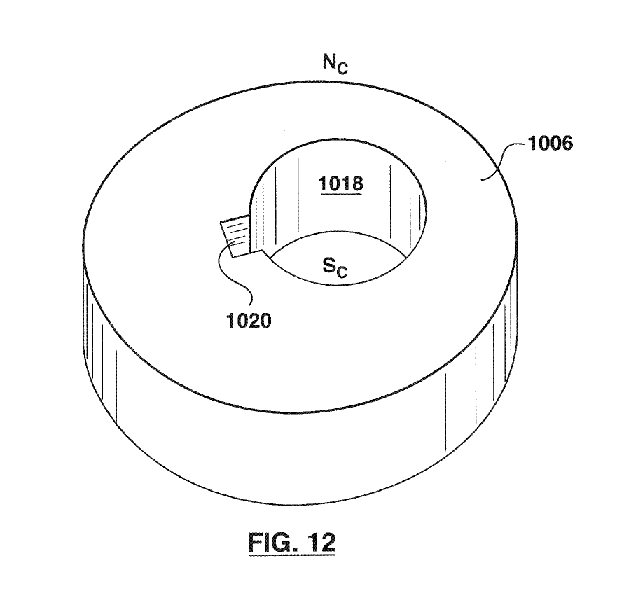

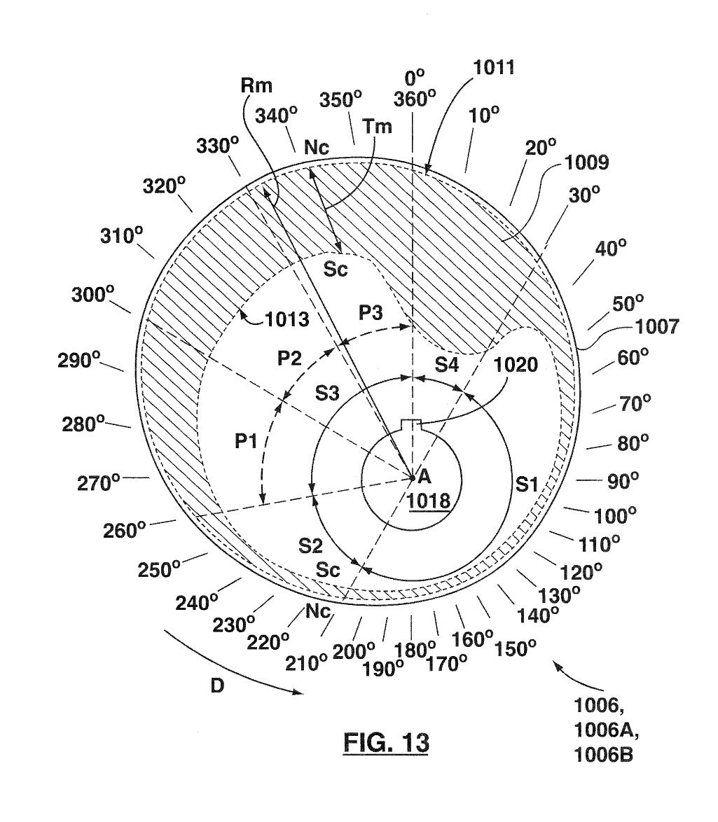

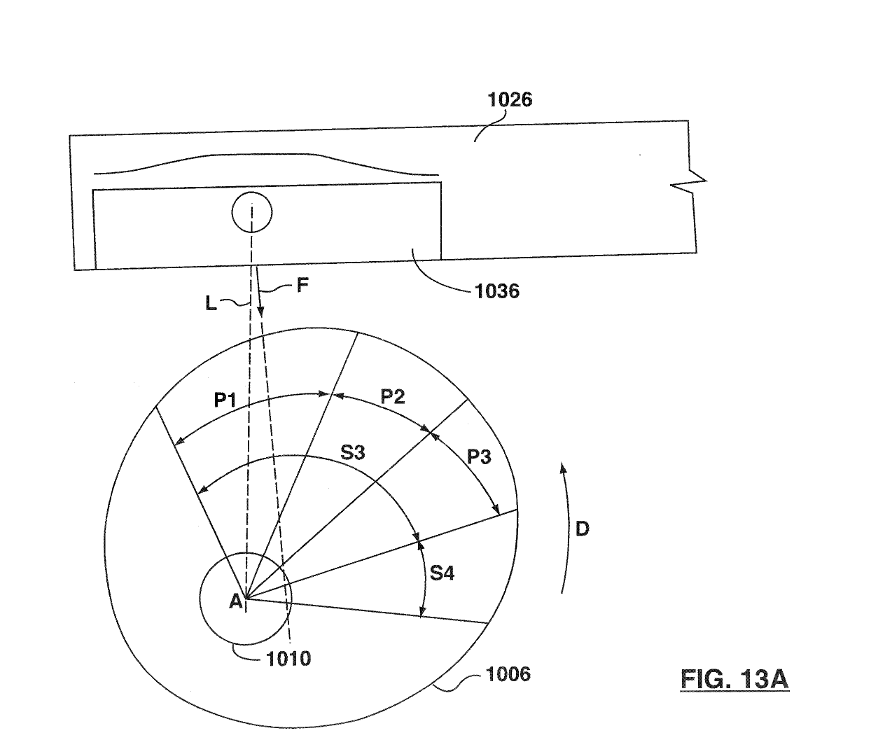

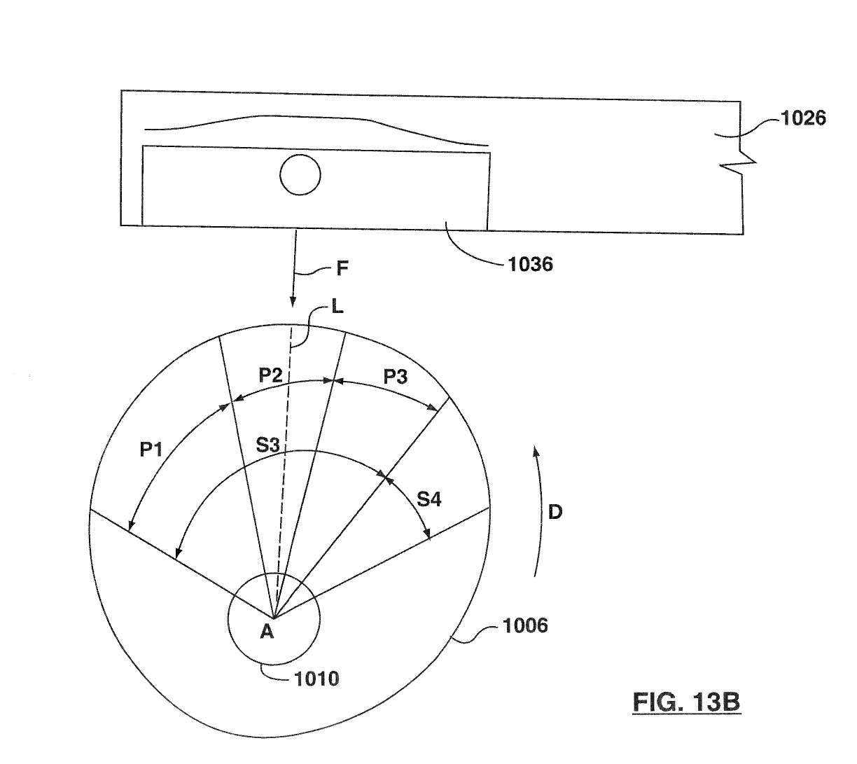

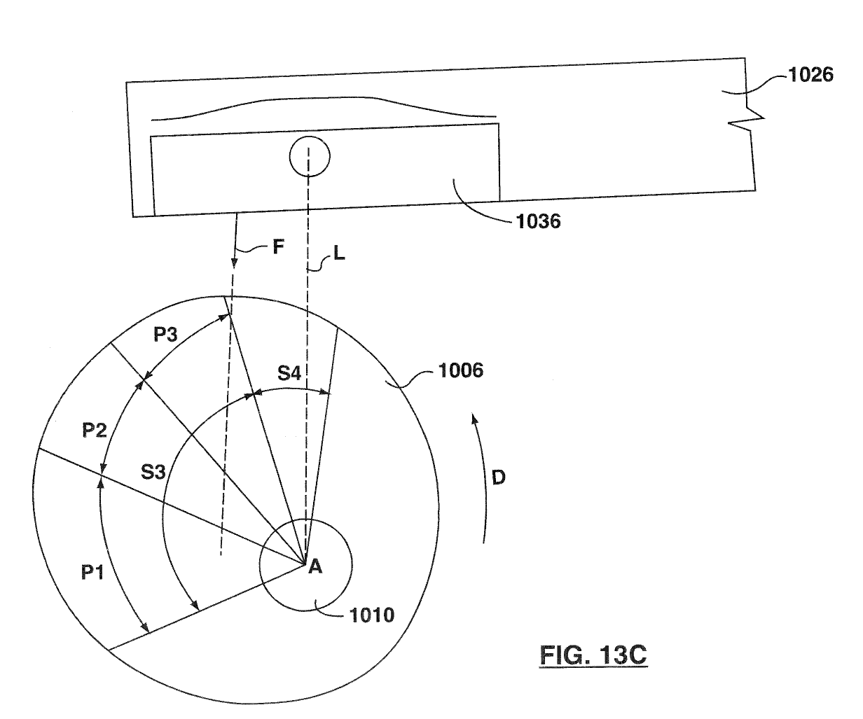

The magnetic cams 1006A and 1006B are substantially identical to each other and each have a distorted elliptical dish or plate like shape or distorted cylindrical shape and are each mounted off-center on the drive shaft 1010 such that each of the magnetic cams provides a respective magnetic field that is asymmetrical relative to the rotational axis of the drive shaft 1010. In the illustrated example, the magnetic cams 1006A and 1006B are each have opposite facing planar sides located in a plane perpendicular to their axis of rotation, an outer perimeter or circumference facing radially away from the axis of rotation, and an inner perimeter or circumference facing the drive shaft 1010 Referring to FIG. 13, in the illustrated example, each magnetic cam 1006 (where 1006 is used to refer generically to cams 1006A and 1006B) has an external housing 1007. The external housing 1007, which for example may be formed from a non-magnetic material such as copper, copper beryllium alloy, or other suitable non-ferrous metal or non-metal, houses a permanent magnet 1009. The cam magnet 1009 has opposite facing planar sides located in a plane perpendicular to the cam's rotation axis A, an outer perimeter or circumference 1011 facing radially away from the axis A, and an inner perimeter or circumference 1013 facing radially inward, with the outer circumference 1011 being the magnetic north pole and the inner perimeter surface 1013 being the magnetic south pole, although the north and south poles can be reversed in some examples. The letters “N_{c}” and “S_{c}” are used in FIGS. 10, 11A, 11B and 13 to denote the radially spaced north pole and south pole, respectively, of the magnetic cams 1006A and 1006B. In the illustrated embodiments the two magnetic cams 1006A and 1006B are both oriented with their respective north pole sides facing radially outward. FIGS. 12 and 13 show an example embodiment of a magnetic cam 1006 that can be used to implement cam 1006A and 1006B in greater detail. Referring in particular to FIG. 13, in one example embodiment the magnetic cam 1006 has an off-center axis of rotation A that is centered in a bore 1018 that is formed through the cam housing 1007 for receiving the drive shaft 1010. The magnetic cam 1006 may define a key slot 1020 in communication with the bore 1018 for receiving a corresponding key surface on the drive shaft 1010 in order to ensure that the cam 1006 is locked to rotate with the drive shaft 1010. In the illustrated example, the outer facing profile of the cam housing 1007 conforms substantially to the outer perimeter 1011 of the cam magnet 1009. The distance Rₘ from the rotational axis A to the outer perimeter 1011 of the cam magnet 1009 varies about the perimeter 1011 of the magnetic cam. Additionally, the radial thickness Tₘ of the cam magnet 1009 between the cam magnet outer face or perimeter 1011 and the cam magnet inner face or perimeter 1013 varies around the cam relative to the axis A. Due to the varying mass or thickness Tₘ of the cam magnet around the perimeter of the cam 1006, the strength and direction of the magnetic field at the cam periphery varies about the cam's perimeter.

Thus, as the cam periphery rotates by a reference point that is radially spaced from the cam (for example, a reference point such as a lever mounted magnet as will be explained in greater detail below), the spacing between the outer surface 1011 of the cam magnet 1009 relative to a reference point will vary due to the variation of the outer cam magnet radius Rₘ. Additionally, the strength of the magnet field at the cam periphery passing by the reference point will vary according to the cam magnet thickness Tₘ. Accordingly, the magnet field provided by the magnetic cam 1006 from the perspective of the reference point is a function of both the radius Rm and the magnet thickness Tₘ. Thus, the strength of the magnetic field provided by the magnetic cam 1006 relative to the axis A varies about the perimeter of the magnetic cam 1006. In one example embodiment, for the purposes of illustration, the magnetic cam 1006 can be divided up into 4 operational semi-circumferential parts or sections relative to a counter clockwise rotational direction as indicated by arrow “D”. The sections are marked on FIG. 13 for reference, along with relative degree markings. In particular, the sections include: a first or “resting” section S1 from approximately 30 degrees to 210 degrees (or from approximately 1:00 o'clock to 7:00 o'clock in the particular orientation shown in FIG. 13); a second or “cam increasing” section S2 from approximately 210 degrees to 260 degrees (or from approximately 7:00 o'clock to 8:30 o'clock); a third or “force performance” section S3 from approximately 260 degrees to 360 degrees (or from approximately 8:30 o'clock to 12:00 o'clock); and a fourth or “cam decreasing” section S4 from approximately 360 or 0 degrees to 30 degrees (or from approximately 12:00 o'clock to 1:00 o'clock). The numbers stated above to define the angular divisions between the sections S1-S4 may be different in different embodiments. In one non-limiting example the profile of magnetic cam 1006 in radial distance from the rotational axis A to the cam perimeter about the circumference of the magnetic cam 1006 is represented approximately in column (a) of table 1 as follows:

TABLE 1
EXAMPLE MAGNETIC CAM PROFILE

| | | (a)Radial | |
|---|---|---|---|
| | | distance Rₘ from | |
| | | rotational axis A | (b) Force |
| | | to outer surface | relative to |
| Rotational | | of cam magnet | direction D |
| Section | Degree | 1009 | on drive shaft |
| Section S4 | 0° | 2.6 | + |
| | 10° | 2.5 | + |
| | 20° | 2.4 | + |
| | 30° | 2.3 | + |
| Section S1 | 40° | 2.0 | + |
| | 50° | 1.7 | |
| | 60° | 1.5 | |
| | 70° | 1.3 | |
| | 80° | 1.2 | |
| | 90° | 1.1 | |
| | 100° | 1.1 | |
| | 110° | 1.0 | |
| | 120° | 1.0 | |
| | 130° | 1.0 | |
| | 140° | 1.1 | |
| | 150° | 1.1 | |
| | 160° | 1.1 | |
| | 170° | 1.1 | |
| | 180° | 1.2 | |
| | 190° | 1.2 | |
| | 200° | 1.3 | |
| Section S2 | 210° | 1.4 | |
| | 220° | 1.5 | |
| | 230° | 1.6 | |
| | 240° | 1.8 | |
| | 250° | 2.0 | − |
| Section S3 | 255° | 2.1 | − |
| | 260° | 2.2 | − |
| | 270° | 2.4 | − |
| | 280° | 2.6 | − |
| | 290° | 2.8 | − |
| | 300° | 2.9 | − |
| | 310° | 3.0 | |
| | 320° | 3.0 | |
| | 330° | 3.0 | |
| | 340° | 2.9 | + |
| | 350° | 2.8 | + |
| | 360° | 2.7 | + |

The above table is representative of possible dimensions only and in some embodiments the shape of the magnetic cam 1006 and magnet 1009 may vary from that stated above. The reference “unit” referred to in column (a) of the above table can be a different value in different examples. For example, 1 unit may equal 1 inch in one example and 1 unit may equal 1 cm in another example, among other possible values. As will be appreciated from FIG. 13 and the above table, the varying radial distance Rₘ of the cam magnet 1009 together with the varying radial thickness Tₘ of the cam magnet 1009 around the circumference of the cam 1006 results in a magnetic field profile that varies in strength relative to axis A about the outer perimeter of the cam 1006, and also relative to distance from the outer perimeter of the cam 1006.

It will be appreciated that in the example embodiment of magnetic cam 1006 shown in FIG. 13, the radius Rₘ of the cam and the radial thickness Tₘ are relatively small throughout the first section S1 compared to the third and fourth sections S3 and S4, with the result that the strength of the radial magnetic field extends further from axis A throughout the third section S3 than as compared to the first section S1. In section S1, as the cam rotates in counterclockwise direction D past a reference point, the cam magnet radius Rₘ decreases, reaches a minimum, then starts increasing slightly. Across section S1, the cam magnet radial thickness Tₘ decreases rapidly in a leading portion section S1 then stays relatively constant. In section S2, the cam magnet radius Rₘ increases, and the radial thickness Tₘ remains relatively constant. In section S3, the cam magnet radius Rₘ quickly increases in portion P1, and then maintains a maximum cam radius through portion P2, then reduces slightly in portion P3. The magnet radial thickness Tₘ (and the corresponding strength of the magnetic field at the cam periphery) increases over a first portion P1 of section S3, remains relatively constant through a second portion P2 of section S3 and then increases slightly through a trailing region of a third portion P3 of section S3. In section S4, the cam magnet radius Rₘ decreases; the radial thickness Tₘ (and the corresponding strength of the magnetic field at the cam periphery) increases over much of section S4 to then decline at a trailing end of section S4. In this regard, the cam magnet 1009 assumes, in one example embodiment, an approximate “L shape” through section S4. The significance of these relative dimensions and the resulting variations in the magnetic field of cam 1006 relative to its rotational axis A will be explained in greater detail below with a description of the operation of the torque multiplier 1000. The above table also includes a column entitled “(c) force relative to direction D on drive shaft 1010” that sets out the direction of a net force applied in a direction of rotation D on the drive shaft 1010 due to repulsive magnetic forces between the cam and a lever mounted magnet (for example, one of the lever mounted magnets 1038, 1036, 1100 or 1102) when the identified perimeter portion of the cam passes by the center point of the lever mounted magnet 1038, 1036, 1100 or 1102. As explained in greater detail below, magnetic coupling of a cam with a particular drive member magnet provides, during each rotational period of the cam, a duration when a negative rotational force results on the drive shaft and a duration when positive rotational force results on the drive shaft.

Returning again to FIG. 10, in one example embodiment the magnetic cams 1006A and 1006B are mounted on the drive shaft 180 degrees out of phase with each other such that during rotation, the minimum radial distance R1 on magnetic cam 1006A trails the minimum radial distance R1 on magnetic cam 1006B by 180 degrees. Magnetic cam 1006A and magnetic cam 1006B provide the driving force for power generator assembly 1004A and 1004B, respectively.

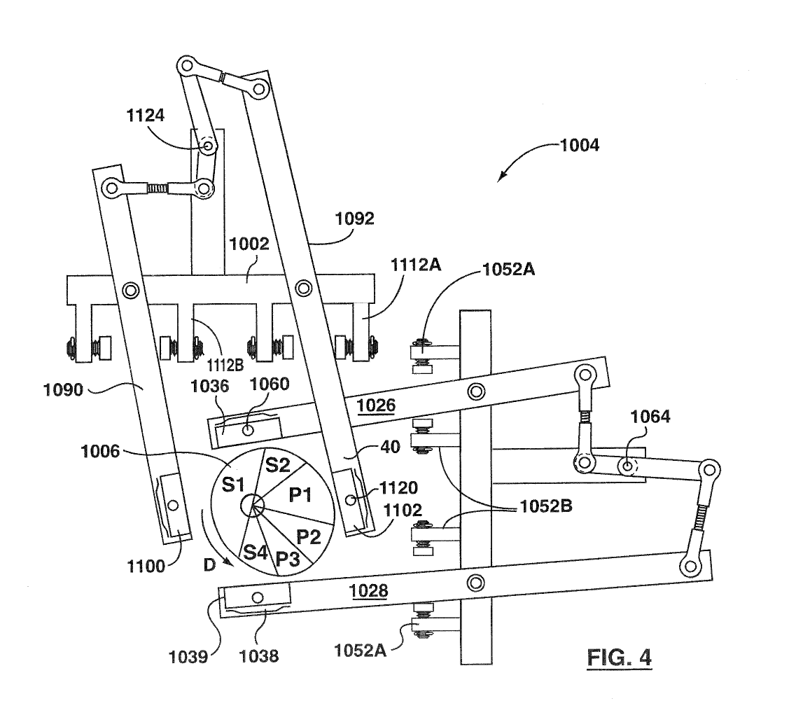

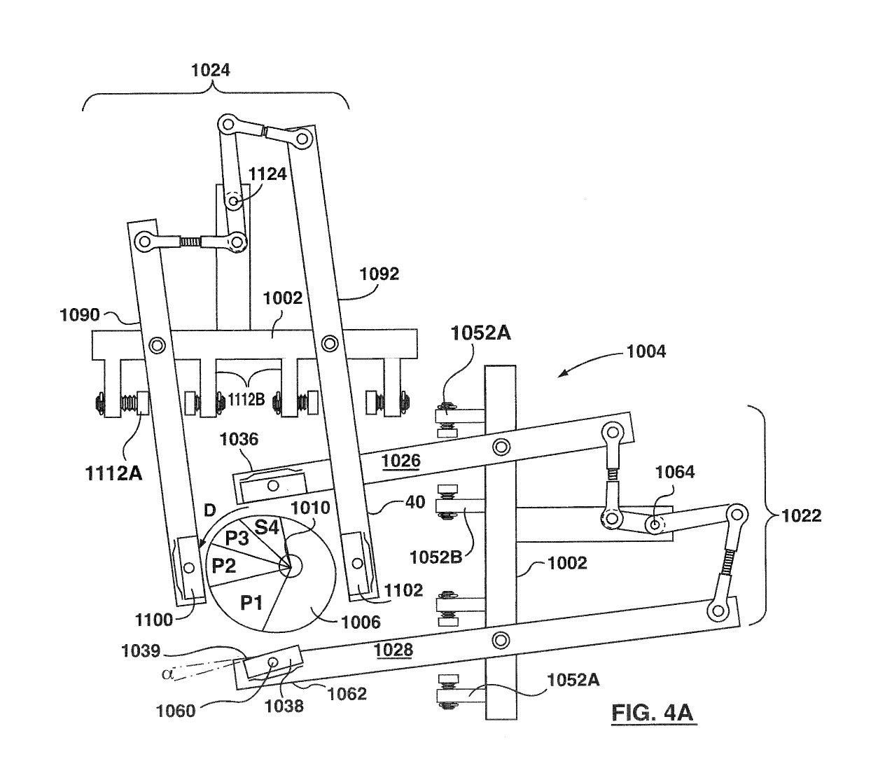

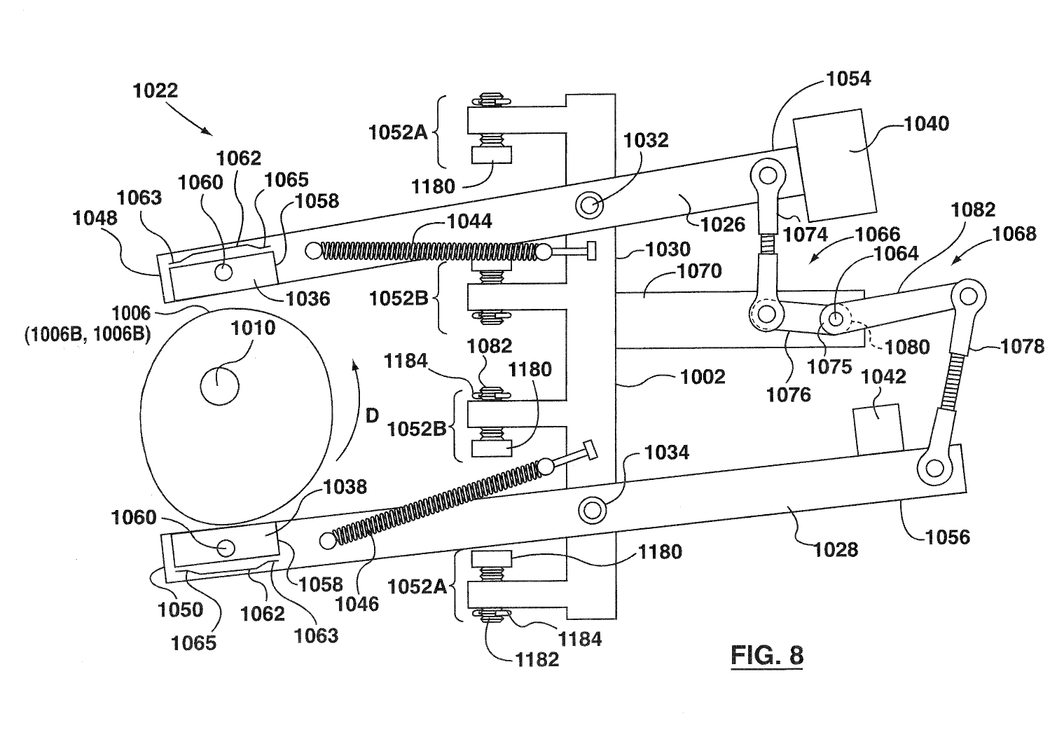

In this regard a single power generator assembly 1004 that is representative of both power generator assembly 1004A and 1004B will now be explained with reference primarily to FIGS. 4-9. Referring first to FIG. 4, the power generator assembly 1004 includes a first lever assembly 1022, which is horizontally oriented in the illustrated embodiment, and a second lever assembly 1024 that is vertically oriented in the illustrated embodiment. An example implementation of horizontally oriented lever assembly 1022 will now be explained with reference to FIG. 8. The horizontal lever assembly 1022 includes first and second drive magnets 1036, 1038 that are mounted in spaced apart relation to the magnetic cam 1006. The drive magnets 1036 and 1038 are each mounted to a respective magnet support member. In the illustrated example, magnet support members take the form of approximately horizontally extending pivoting levers 1026, 1028 that are each pivotally mounted by respective shoulder bolts 1032, 1034 at spaced apart locations on a frame member 1030 of the torque multiplier frame 1002. In some example embodiments the shoulder bolts 1032, 1034 pass through rotating bearings provided in the levers 1026, 1028 to provide a low friction pivot mount. The first pivoting lever 1026 has a distal end 1048 supporting a permanent magnet 1036 above the magnetic cam 1006 and the second pivoting lever 1028 has a distal end 1050 supporting a permanent magnet 1038 below the magnetic cam 1006.

The pivoting levers 1026 and 1028 are each pivotally mounted to independently move, with their respective drive magnets 1036, 1038, between a home or resting position and an activated position. In one example embodiment, the first lever 1026 is biased by a tension spring assembly 1044 towards a home or resting position in which its magnet bearing end 1048 is pivoted downward. The tension spring assembly 1044 extends between the first lever 1026 and the frame member 1030, and may be adjustable in some implementations. Similarly, the second lever 1028 is biased by a tension spring assembly 1046 towards a home or resting position in which its magnet bearing end 1050 is pivoted towards an upward position. The tension spring assembly 1046 extends between the second first lever 1028 and the frame member 1030, and may be adjustable in some implementations. In some example embodiments respective over-travel limiters 1052A are provided on the frame member 1030 to set the maximum pivot limits of the levers 1026 and 1028 in their activated positions, and respective over-travel limiters 1052B are provided on the frame member 1030 to set the maximum pivot limits of the levers 1026 and 1028 in their resting positions. In an example embodiment, the over-travel limiters 1052A and 1052B each include a stop member 1180 for contacting the lever, a screw 1182 for adjusting the location of the stop member 1180, and a lock nut 1184 for locking the position of the screw 1182. Counter weights 1040, 1042 may be provided on the levers 1026 and 1028, respectively, to balance the levers so that they can be easily pivoted in the manner described below. In the illustrated example embodiment, the counter weights 1040, 1042 are located at the non-magnet bearing ends 1054 and 1056, respectively of levers 1026 and 1028.

As noted above, a permanent magnet 1036 is mounted near one end 1048 of the first lever 1026 above the magnetic cam 1006. In an example embodiment, the permanent magnet 1036 is rectangular block shaped and secured within a pocket or housing 1058 that is pivotally mounted about a central pivot axis by a pin 1060 on a side of the lever 1026. In one example embodiment, the pivot axis of the permanent magnet 1036 is substantially vertically aligned with the drive shaft 1010 of the magnetic cam 1006. A leaf spring 1062 is secured to the lever 1026 to limit the degree to which the lever-mounted magnet 1036 can pivot about pin 1060. In particular the leaf spring 1062 is configured to allow the lever-mounted magnet 1036 to pivot about its central pivot axis between a first pivot position and a second pivot position due to magnetic coupling between the magnet 1036 and the cam 1006 as the cam rotates. In one example embodiment, the leaf spring 1062 is fixed at one end 1063 to the lever 1026, and contact between the housing 1058 of magnet 1036 and the fixed or stationary end 1063 of the leaf spring prevents the magnet 1036 from rotating any further clockwise than its first pivot position. In one example embodiment, the opposite end 1065 of the leaf spring 1062 is not secured to the lever 1026 such that the end 1065 gets deformed or displaced from a normal resting position as the magnet 1036 and its associated housing 1058 pivots counterclockwise into its second pivot position. Accordingly, in at least some example embodiments the leaf spring 1062 biases the magnet 1036 into its first pivot position, and in the first pivot position the magnet 1036 cannot rotate any further in a clockwise direction. Due to changes in the magnitude and direction of repulsive magnetic forces between the magnetic cam 1006 and the magnet 1036 as the cam 1006 rotates, for a duration of each rotational period of the cam 1006, the magnet 1036 pivots counterclockwise from its first pivot position to its second pivot position deforming the leaf spring 1062 as it pivots until further counterclockwise rotation of the magnet 1036 is prevented. Changes in one or both of the direction and magnitude of the magnetic forces between the magnet 1036 and the cam 1006 as the cam continues to rotate are such that the leaf spring 1062 and magnetic force from the magnetic cam 1006 subsequently force the magnet 1036 back into the first pivot position. Movement of the magnet 1036 between its first and second pivot positions during rotation of the magnetic cam 1006 will become more apparent in the description below. The permanent magnet 1038 is also a rectangular shaped block mounted in a similar manner near the end 1050 of the second lever 1028 below the magnetic cam 1006. The permanent magnet 1038 is secured within a pocket or housing 1058 that is pivotally mounted about a central pivot axis by a pin 1060 on a side of the lever 1028. In one example embodiment, the pivot axis of the permanent magnet 1038 is substantially vertically aligned with the drive shaft 1010 of the magnetic cam 1006. A leaf spring 1062 is also secured to the lever 1028 to limit the degree to which the lever-mounted magnet 1038 can pivot about pin 1060. In particular the leaf spring 1062 is configured to allow the lever-mounted magnet 1038 to pivot about its central axis between a first pivot position and a second pivot position. The operation of the leaf spring 1062 mounted on lever 1028 is similar to that of the leaf spring 1062 mounted on lever 1026. In one example embodiment, the leaf spring 1062 is fixed at one end to the lever 1028, and contact between the housing 1058 of magnet 1038 and the fixed end of the leaf spring prevents the magnet 1038 from rotating any further clockwise than its first pivot position. The opposite end of the leaf spring 1062 is not secured to the lever 1028 such that that end gets deformed or displaced from a normal resting position as the magnet 1038 and its associated housing 1038 pivots counterclockwise into its second pivot position. Accordingly, in at least some example embodiments the leaf spring 1062 biases the magnet 1038 into its first pivot position, and in the first pivot position the magnet 1038 cannot rotate any further in a clockwise direction. The lever mounted magnets 1036 and 1038 are each substantially aligned in a common vertical plane with the magnetic cam 1006.

Referring to FIG. 11A, in one example embodiment the magnetic north poles of each of the lever-mounted magnets 1036, 1038 face towards the magnetic cams 1006A, 1006B, and the south poles of each of the lever-mounted magnets 1036, 1038 face away from the south poles of the magnetic cams 1006A, 1006B. In such a configuration, the north magnetic fields (illustrated by dashed line N_{L}) produced by the lever mounted magnets 1036 and 1038 oppose the north magnetic field (illustrated by dashed line N_{C}) produced by their associated magnetic cams 1006A, 1006B. In some example embodiment, the poles of each of the magnets can be inverted to achieve the same repulsive effect.

Returning again to FIG. 8, the relative magnetic orientation of the lever-mounted magnets 1036, 1038 and the magnetic cam 1006 results in the magnetic cam 1006 applying repulsive forces on the lever-mounted drive magnets 1036, 1038. The asymmetrical configuration of magnetic cam 1006 is such that the magnitude and direction of the repulsive magnetic forces applied by the magnetic cam 1006 on the lever-mounted magnets 1036, 1038 varies as the magnetic cam rotates at a substantially constant speed, which as described in greater detail below is used to reciprocate the first and second levers 1026 and 1028 (and their respective drive magnets 1036, 1038) between their respective resting states and their respective activated states.

The non-magnetized end 1054 of the first lever 1026 is connected by a mechanical linkage 1066 to a first drive shaft 1064 that is rotatably mounted to frame component 1070 of the torque multiplier frame 1002. In an example embodiment, the mechanical linkage 1066 converts downward pivoting motion of the non-magnetized end 1054 of the first lever 1026 into a counter-clockwise rotational force on the first output shaft 1064. In this regard, the mechanical linkage 1066 includes a first force transmitter arm 1074 that has one end pivotally mounted to the non-magnetized end 1054 of the first lever 1026 and a second end pivotally secured to a first end of a second force transmitter arm 1076. The second end of the second force transmitter arm 1076 is connected by a one-way roller clutch bearing 1075 to the first output shaft 1064 such that downward movement of the first end of the second force transmitter arm 1076 applies counter-clockwise force on first output shaft 1064 while allowing the second force transmitter arm 1076 to disengage from the first output shaft without applying any significant clockwise force on the first output shaft 1064 upon upward movement of the first end of the second force transmitter arm 1076.

Similarly, the non-magnetized end 1056 of the second lever 1028 is also connected by a mechanical linkage 1068 to the first output shaft 1064. In an example embodiment, the mechanical linkage 1068 converts upward pivoting motion of the non-magnetized end 1056 of the second lever 1028 into a counter-clockwise rotational force on the first output shaft 1064. In this regard, the mechanical linkage 1068 includes a first force transmitter arm 1078 that has one end pivotally mounted to the non-magnetized end 1056 of the second lever 1028 and a second end pivotally secured to a first end of a second force transmitter arm 1082. The second end of the second force transmitter arm 1082 is connected by a one-way roller clutch bearing 1080 to the first output shaft 1064 such that upward movement of the first end of the second force transmitter arm 1082 applies counter-clockwise force on first output shaft 1064 while allowing the second force transmitter arm 1082 to disengage from the first output shaft without applying any significant clockwise force on the first output shaft 1064 upon downward movement of the first end of the second force transmitter arm 1082. At least some of the force transmitter arms 1074, 1076, 1082 and 1078 may have adjustable lengths for calibrating the torque multiplier 1000.

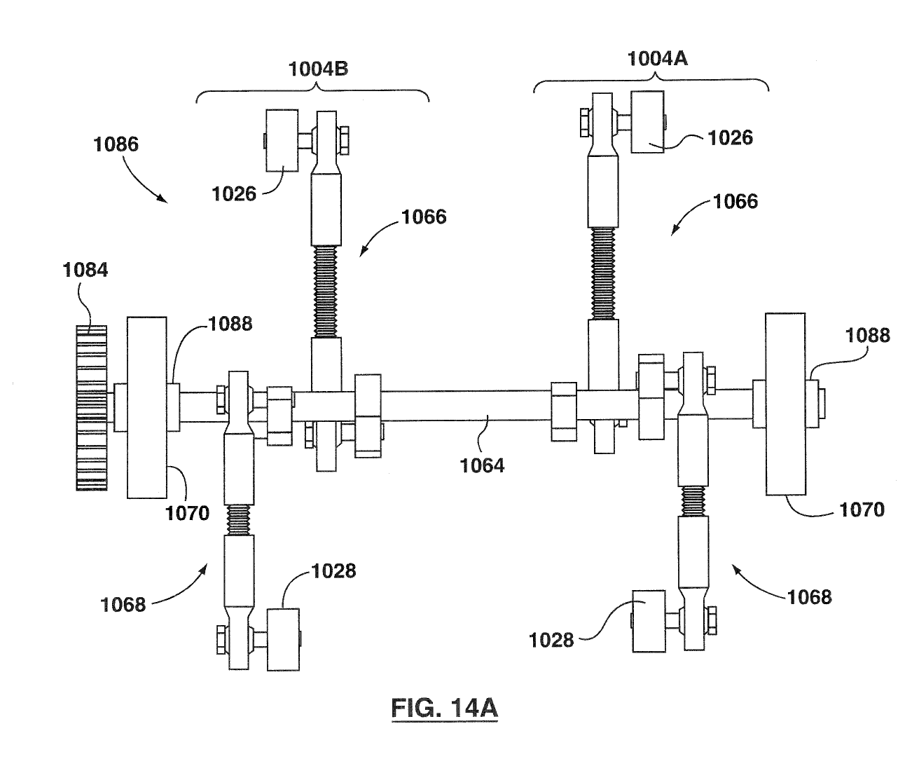

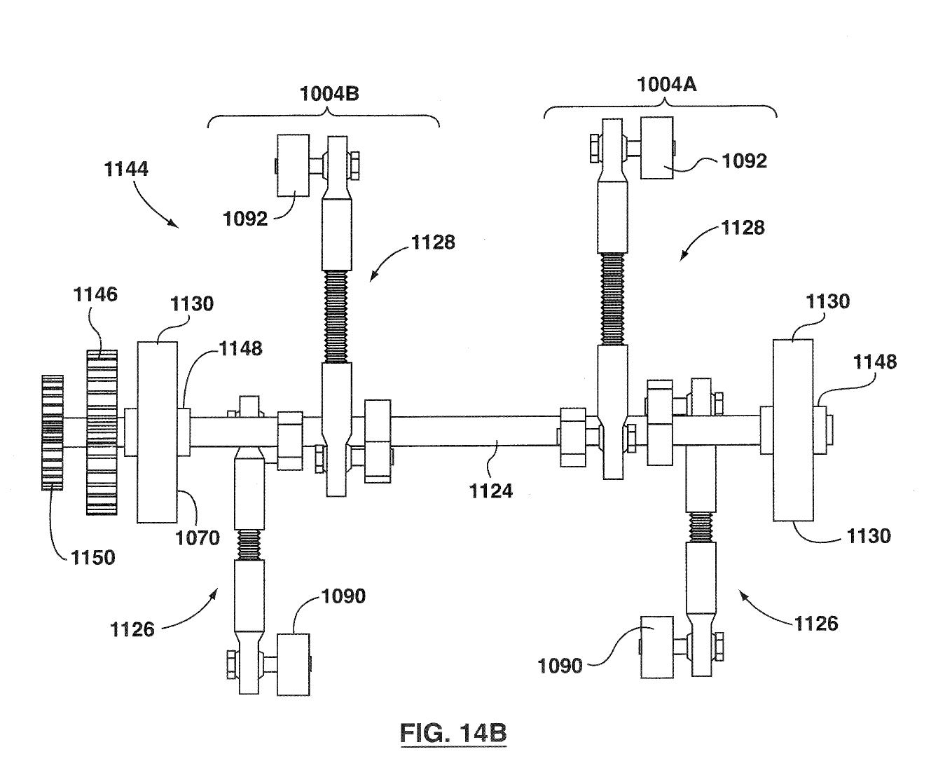

The first output shaft 1064 is part of a first output drive assembly 1086, a back view of which is shown in FIG. 14A. The horizontal lever arms 1026 and 1028 and mechanical linkages 1066, 1068 that are part of the first power generator assembly 1004A are configured to drive the shaft 1064 in a counterclockwise direction in the manner described above and the horizontal lever arms 1026 and 1028 and mechanical linkages 1066, 1068 that are part of the second power generator assembly 1004B are also configured to drive the shaft 1064 in a counterclockwise direction in the manner described above. In an example embodiment the first output shaft 1064 is mounted at opposite ends to frame members 1070 by roller clutch bearings 1088 that allow the first output shaft 1064 to rotate in a counterclockwise direction but not in a clockwise direction. In an example embodiment, a first output drive sprocket 1084 is connected to rotate with one end of the output shaft 1064.

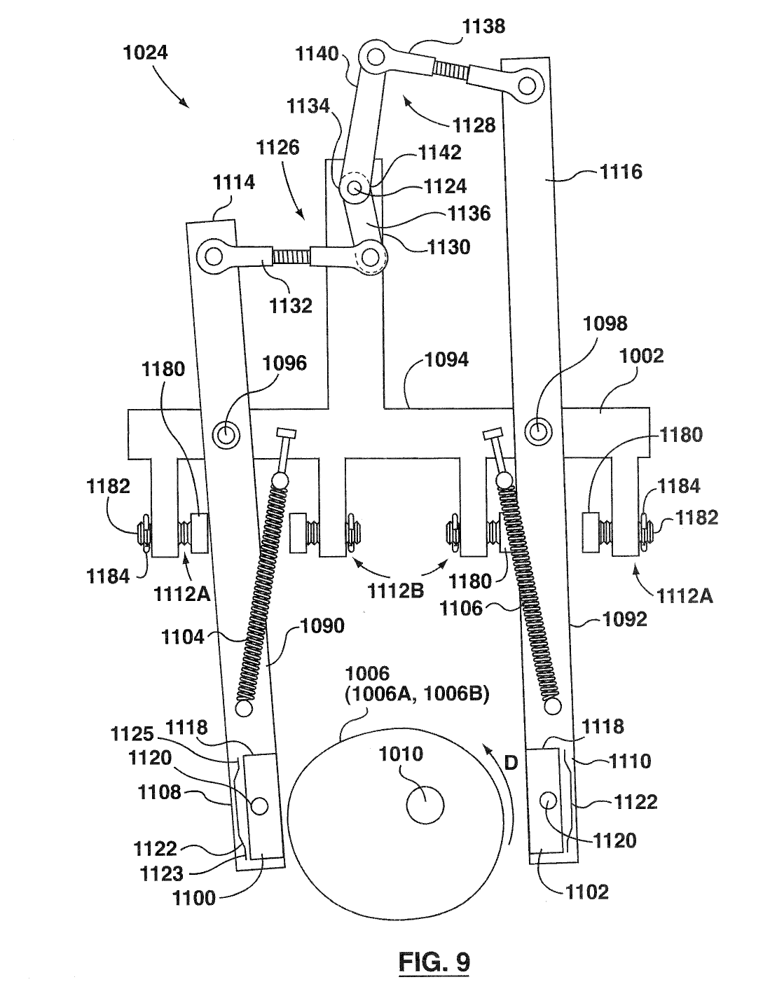

The vertically oriented lever assembly 1024 is configured to operate in a manner similar to horizontally oriented lever assembly 1022. An example implementation of vertically oriented lever assembly 1024 will now be explained in greater detail with reference to FIG. 9. The vertical lever assembly 1024 includes drive magnets 1100, 1102 that are mounted in spaced apart relation to the magnetic cam 1006. The drive magnets 1100 and 1102 are each mounted to a respective magnet support member. In the illustrated example, magnet support members take the form of first and second approximately vertically extending pivoting levers 1090, 1092 that are each pivotally mounted by respective shoulder bolts 1096, 1098 at spaced apart locations on a frame member 1094 of the torque multiplier frame 1002. In some example embodiments the shoulder bolts 1096, 1098 pass through rotating bearings provided in the levers 1090, 1092 to provide a low friction pivot mount. The first pivoting lever 1090 has a distal end 1108 supporting a permanent magnet 1100 horizontally aligned with and to one side (the left side in FIG. 9) of the magnetic cam 1006 and the second pivoting lever 1092 has a distal end 1110 supporting a permanent magnet 1102 horizontally aligned with and to the other side (the right side in FIG. 9) of the magnetic cam 1006.

The pivoting levers 1090 and 1092 are each pivotally mounted to independently move with their respective drive magnets 1100, 1102 between a home or resting position and an activated position. In one example embodiment, the first lever 1090 is biased by a tension spring assembly 1104 towards a home or resting position in which its magnet bearing end 1108 is pivoted towards the magnetic cam 1006. The tension spring assembly 1104 extends between the first lever 1090 and the frame member 1094, and may be adjustable in some implementations. Similarly, the second lever 1092 is biased by a tension spring assembly 1106 towards a home or resting position in which its magnet bearing end 1110 is pivoted towards the magnetic cam 1006. The tension spring assembly 1106 extends between the second first lever 1092 and the frame member 1094, and may be adjustable in some implementations. In some example embodiments respective over-travel limiters 1112A are provided on the frame member 1094 to set the maximum pivot limits of the levers 1090 and 1092 in their activated positions, and respective over-travel limiters 1112B are provided on the frame member 1094 to set the maximum pivot limits of the levers 1090 and 1092 in their resting positions. In an example, the over-travel limiters 1112A and 1112B each include a stop member 1180 for contacting the lever, a screw 1182 for adjusting the location of the stop member 1180, and a lock nut 1184 for locking the position of the screw 1182.

As noted above, a permanent magnet 1100 is mounted near one end 1108 of the first lever 1090. In an example embodiment, the permanent magnet 1100 is rectangular block shaped and secured within a pocket or housing 1118 that is pivotally mounted by a pin 1120 on a side of the lever 1090. A leaf spring 1122 is secured to the lever 1090 to limit the degree to which the lever-mounted magnet 1100 can pivot about pin 1120. In particular the leaf spring 1122 is configured to allow the lever-mounted magnet 1100 to pivot about its central pivot axis between a first pivot position and a second pivot position due to magnetic coupling between the magnet 1100 and the cam 1006 as the cam rotates. In one example embodiment, the leaf spring 1122 is fixed at one end to the lever 1090, and contact between the housing 1118 of magnet 1100 and the fixed end of the leaf spring prevents the magnet 1100 from rotating any further clockwise than its first pivot position. In one example embodiment, the opposite end of the leaf spring 1122 is not secured to the lever 1090 such that that end gets deformed or displaced from a normal resting position as the magnet 1100 and its associated housing 1118 pivots counterclockwise into its second pivot position. Accordingly, in at least some example embodiments the leaf spring 1122 biases the magnet 1100 into its first pivot position, and in the first pivot position the magnet 1100 cannot rotate any further in a clockwise direction. Due to changes in the magnitude and direction of repulsive magnetic forces between the magnetic cam 1006 and the magnet 1100 as the cam 1006 rotates, for a duration of each rotational period of the cam 1006, the magnet 1100 pivots counterclockwise from its first pivot position to its second pivot position deforming the leaf spring 1122 as it pivots until further counterclockwise rotation of the magnet 1100 is prevented. Changes in one or both of the direction and magnitude of the magnetic forces between the magnet 1100 and the cam 1006 as the cam 1006 continues to rotate are such that the leaf spring and magnetic force from the magnetic cam 1006 subsequently force the magnet 1100 back into the first pivot position. In one example embodiment, the pivot axis of the permanent magnet 1100 is substantially horizontally aligned with the drive shaft 1010 of the magnetic cam 1006. The permanent magnet 1102 is also a rectangular shaped block mounted in a similar manner near the end 1110 of the second lever 1092. The permanent magnet 1102 is secured within a pocket or housing 1118 that is pivotally mounted by a pin 1120 on a side of the lever 1092. A leaf spring 1122 is also secured to the lever 1092 to limit the degree to which the lever-mounted magnet 1102 can pivot about pin 1120. In particular the leaf spring 1122 is configured to allow the lever-mounted magnet 1102 to pivot about its central axis between a first pivot position and a second pivot position in a similar manner that the leaf spring 1122 mounted on lever 1090 acts on the lever mounted magnet 1100.

Referring to FIG. 11B, in one example embodiment the magnetic north poles of each of the lever-mounted magnets 1100, 1102 face towards the magnetic cams 1006A, 1006B, and the south poles of each of the lever-mounted magnets 1100, 1102 face away from the south poles of the magnetic cams 1006A, 1006B. In such a configuration, the north magnetic fields (illustrated by dashed line N_{L}) produced by the lever mounted magnets 1100 and 1102 oppose the north magnetic field (illustrated by dashed line N_{C}) produced by their associated magnetic cams 1006A, 1006B. In some example, the poles of each of the magnets can be reversed to achieve the same repulsive effect.

Returning again to FIG. 9, the relative magnetic orientation of the lever-mounted magnets 1100, 1102 and the magnetic cam 1006 results in the magnetic cam 1006 applying repulsive forces on the lever-mounted magnets 1100, 1102. The asymmetrical configuration of magnetic cam 1006 is such that the magnitude and direction of the repulsive magnetic forces applied by the magnetic cam 1006 on the lever-mounted magnets 1100, 1102 varies as the magnetic cam rotates at a substantially constant speed, which as described in greater detail below is used to reciprocate the first and second levers 1090 and 1092 between their respective resting states and their respective activated states.

The non-magnet bearing end 1114 of the first lever 1090 is connected by a mechanical linkage 1126 to a second output shaft 1124 that is rotatably mounted to frame component 1130 of the torque multiplier frame 1002. In an example embodiment, the mechanical linkage 1126 converts inward pivoting motion of the non-magnetized end 1114 of the first lever 1090 into a counter-clockwise rotational force on the second output shaft 1124. In this regard, the mechanical linkage 1126 includes a first force transmitter arm 1132 that has one end pivotally mounted to the non-magnetic end 1114 of the first lever 1090 and a second end pivotally secured to a first end of a second force transmitter arm 1136. The second end of the second force transmitter arm 1136 is connected by a one-way roller clutch bearing 1134 to the second output shaft 1124 such that counter clockwise movement of the first end of the second force transmitter arm 1136 applies counter-clockwise force on second output shaft 1124 while allowing the second force transmitter arm 1136 to disengage from the second output shaft without applying any significant clockwise force on the second output shaft 1124 upon clockwise movement of the first end of the second force transmitter arm 1136.

Similarly, the non-magnetic end 1116 of the second lever 1092 is also connected by a mechanical linkage 1128 to the first output shaft 1124. In an example embodiment, the mechanical linkage 1128 converts inward pivoting motion of the non-magnetic end 1116 of the second lever 1092 into a counter-clockwise rotational force on the second output shaft 1124. In this regard, the mechanical linkage 1128 includes a first force transmitter arm 1138, a second force transmitter arm 1140, and a one-way roller clutch bearing 1142 that are configured in a manner similar to mechanical linkage 1126. At least some of the force transmitter arms 1132, 1136, 1138, 1140 may have adjustable lengths for calibrating the torque multiplier 1000.

The second output shaft 1124 is part of a second output drive assembly 1144, a top view of which is shown in FIG. 14B. The vertical lever arms 1090 and 1092 and mechanical linkages 1126, 1128 that are part of the first power generator assembly 1004A are configured to drive the shaft 1124 in a counterclockwise direction in the manner described above and the vertical lever arms 1090 and 1092 and mechanical linkages 1126, 1128 that are part of the second power generator assembly 1004B are also configured to drive the shaft 1124 in a counterclockwise direction in the manner described above. In an example embodiment the second output shaft 1124 is mounted at opposite ends to frame members 1130 by roller clutch bearings 1148 that allow the second output shaft 1124 to rotate in a counterclockwise direction but not in a clockwise direction. In an example embodiment, a second output drive sprocket 1146 is connected to rotate with one end of the output shaft 1124. As indicated in FIGS. 1 and 3, in an example embodiment the first output sprocket 1084 on the first output shaft 1064 is linked by a connecting chain 1154 to a sprocket 1150 that is mounted to rotate with the second output shaft 1124 such that second output shaft 1124 provides the summed output of both the horizontally oriented levers and the vertically oriented levers. The second output drive sprocket 1146 is in turn linked by chain 1156 to a final output sprocket 1152 that turns a final output shaft 1158 which provides the total output for the torque multiplier 1000.

In example embodiments the components of the torque multiplier 1000 that are close to the magnetic cam and the lever mounted magnets are formed from non-magnetic non-ferrous materials so as to avoid interfering with or being affected by the magnet fields of the magnetic cam and the lever mounted magnets.

An overview of the components of the torque multiplier 1000 having been provided, operation of one of the power generator assemblies 1004 will now be described with reference to FIGS. 4 to 7 which illustrate four different rotational positions of the magnetic cam 1006. Starting with FIG. 4, in an example embodiment during operation of the torque multiplier 1000 the drive shaft 1010 rotates in counterclockwise direction D under power supplied from drive motor 1016, driving the magnetic cam 1006 at a substantially constant speed in a counterclockwise direction. As the magnetic cam 1006 rotates, its asymmetrical magnetic field repulses the magnets in levers 1028, 1090, 1092 and 1026 to cause each of the levers to independently pivot from a home or resting position to an activated state as the largest radius region of the cam 1006 passes by the lever's magnet, without any physical contact between the magnetic cam 1006 and any of the levers 1028, 1090, 1092 and 1026 or their associated magnets 1036, 1038, 1100 and 1102. In FIG. 4, the lower horizontally oriented lever 1028 has been repelled into a fully activated position with the lever mounted magnet 1038 located adjacent to and spaced apart from the largest radius portion of the magnetic cam 1006, namely rotational section S3 (see FIG. 13).

In the fully activated position, the lever 1028 contacts its respective travel limiter 1052A to prevent any further outer pivoting of the lever 1028. In an example, with reference to FIGS. 4 and 13, the magnetic coupling and resulting forces between the magnetic cam 1006 and the lever 1028 is as follows. As noted above, in an example embodiment the magnetic cam 1006 can be notionally divided into four rotational or semi-circumferential sections S1-S4. The rotational sections S1-S4 each successively pass by the magnet 1038 located on the end of lever 1028 during each rotation of the magnetic cam 1006. When the outer perimeter of section S4 of the magnetic cam 1006 passes by the magnet 1038 the strength of the repulsive coupling between magnet 1038 and magnetic cam 1006 is strong enough that the lever 1028 generally remains displaced in its activated position with the lever 1028 resting against travel limiter 1052A for at least a substantial portion of the time that section S4 passes by the magnet 1038. In section S1, the radius and the thickness Tₘ of the magnetic cam 1006 reduces relatively quickly such that as section S1 rotates by the magnet 1038 the repulsive magnetic forces between the magnetic cam 1006 and the magnet 1038 are not sufficient to maintain the lever 1028 in its activated position, and the lever 1028 returns to its home or resting position resting against inner travel limiter 10526. The lever 1028 remains in its resting position throughout much of the time that the section 51 rotates by the magnet 1038. The radius of the magnetic cam 1006 increases along section S2 such that the repulsive magnetic force applied by the cam 1006 on the magnet 1038 increases substantially as section S2 passes by the magnet 1038. In some examples, the increasing magnetic coupling as section S2 passes by the magnetic 1038 is not enough to displace the lever 1028 from its resting position. Section S3 of the magnetic cam 1006 is the largest radius portion of the cam and can be notionally divided into three successive rotational or semi-circular portions P1, P2 and P3. As portion P1 (which in the illustrated example embodiment of FIG. 13 is the angular portion from approximately 250 degrees to 300 degrees, and which has an increasing radius in the rotational direction D) passes by the magnet 1038 the repulsive magnetic coupling between the magnetic cam 1006 and the magnet 1038 increases and is sufficient to move the lever 1028 into its activated position against stop limiter 1052A as shown in FIG. 4. In one example embodiment, the lever 1028 reaches its fully activated position after the end of portion P1 passes by the pin 1060.

The radius of the magnetic cam 1006 remains substantially constant throughout rotational portion P2 (which in the illustrated example embodiment of FIG. 13 is the portion from approximately 300 degrees to 330 degrees) and rotational portion P3 (which in the illustrated example embodiment of FIG. 13 is the portion from approximately 330 degrees to 360 degrees). As rotational portions P2 and P3 of section S3 pass by the magnet 1038, the lever 1028 remains in its activated position resting against stop limiter 1052A. As a result of the asymmetrical profile and off-center mounting of the magnetic cam 1006 and the orientation of lever 1028 and its pivotally mounted magnet 1038, once rotational portion P3 starts to pass by the center of the lever mounted magnet 1038 the repulsive magnetic coupling between magnetic cam 1006 and magnet 1038 is a sufficient magnitude and direction such that a positive rotational force in direction D is applied by the lever mounted magnet 1038 on the magnetic cam 1006, thereby returning energy to the drive shaft 1010. Similarly, as section S4 passes by the magnet 1038, the direction and magnitude of the repulsive magnetic coupling between magnetic cam 1006 and magnet 1038 is such that the positive rotational force in direction D continues to be applied by the lever mounted magnet 1038 on the magnetic cam 1006 for at least some of the duration during which section S4 passes by the magnet 1038. Thus, the magnetic forces that result as portions of sections S3 and S4 of the magnetic cam 1006 pass by the magnet 1038 push the magnetic cam 1006 forward in rotational direction D to return energy to the drive shaft 1010. As portion P3 of section S3 and at least a first part of section S4 pass by the magnet 1038, the repulsive magnetic forces are substantially directed to the trailing end of the first magnet 1038 relative to a rotational direction of the magnetic cam. Accordingly, in one example embodiment, as portion P1 of section S3 of the magnetic cam 1006 passes the lever mounted magnet 1038 the lever 1028 is moved from its resting position to its active position causing an output torque to be provided on output shaft 1064. As portion P2 of the magnetic cam 1006 passes the lever mounted magnet 1038 the lever 1028 is maintained in its activated position. As the portion P3 of section S3 and as at least part of section S4 of the magnetic cam 1006 passes by the lever mounted magnet 1038, the magnetic coupling actually pushes the magnetic cam 1006 in the direction D to return energy to the drive shaft 1010.

In an example embodiment, the lever mounted magnet 1038 pivots about centrally located pin 1060 between first pivot position and second pivot position limits that are defined by the leaf spring 1062 as the various sections of magnetic cam 1006 rotate by the magnet 1038. In one example, when the magnet 1038 is in its first pivot position, it is prevented from rotating any further clockwise (e.g. in a direction opposite to the rotation of magnetic cam 1006) by the fixed end of leaf spring 1062, and when the magnet 1038 is in its second pivot position it is prevented from any further counterclockwise rotation by the leaf spring 1062. Other stop mechanisms can be used to limit the pivoting of the magnet 1038 besides or in addition to a leaf spring. In one example, the magnet 1038 remains in its first pivot position, which is shown in FIG. 4, for substantially the entire rotation of the magnetic cam 1006 except when portion P1 of section S3 of the magnetic cam 1006 passes immediately by the leading end 1039 (see FIG. 4A) of magnet 1038. As noted above, when portion P1 of section S3 of the magnetic cam, 1006 passes by the magnet 1038 the lever 1028 is displaced from its home or resting position to its activated position.

In one example embodiment, magnetic coupling between the cam 1006 and the magnet 1038 causes the magnet 1038 to pivot counter clockwise from its first pivot position to its second pivot position just before or as the lever 1028 moves from its resting position to its activated position. Thus, in one example the magnet 1038 pivots counterclockwise to its second pivot position just as a leading portion of magnetic cam portion P1 first passes by a front end 1039 of magnet 1038. Once the lever 1028 begins moving to its activated position, changes in the magnitude and direction of the repulsive magnetic forces between the cam and the magnet 1038 are such that the magnet 1038 then pivots clockwise back to its first pivot position under the force of leaf spring 1062 and repulsive magnetic forces from the magnetic cam 1006 at which point the fixed end of leaf spring 1062 prevents the magnet 1038 from rotating any further in the clockwise direction. FIG. 4A illustrates the magnet 1038 displaced counterclockwise by a pivot angle α (alpha) into its second pivot position as a leading part of portion P1 of the magnetic cam 1006 rotates by a front end 1039 of the magnet 1038. In some examples the angle α that magnet 1038 pivots when moving between the first pivot position and the second pivot position is in the range of 1 degree to 25 degrees, however in some applications a pivot degree of larger than 25 degrees may be used. In example embodiments, the pivoting angle of the magnet 1038 between its first pivot position and second pivot position is such that the repulsive magnetic force between the magnetic cam 1006 and the magnet 1038 is substantially directed to the center of the pin 1060 that mounts the magnetic block 1038 as the lever 1028 moves from its resting position to its activated position, in order to efficiently direct the force required to displace the lever 1028. In an example embodiment, when the magnet 1038 is in its second pivot position the magnetic force field from the magnetic cam and the magnetic force field from the magnet 1038 are substantially directed towards each other so that force is efficiently applied to push the lever to its activated position.

As noted above, as the lever 1028 begins moving from its resting position to its activated position, the change in the magnetic coupling forces between the cam 1006 and the magnet 1038 cause the magnet to rotate clockwise back to its first pivot position under force applied by the leaf spring 1062 and the repulsive magnetic force from the magnetic cam 1006 and once the magnet 1038 is in its first pivot position further clockwise rotation is prevented by the fixed end of leaf spring 1062. In examples, the first pivot position of the magnet 1038 is selected so that as portion P3 and section S4 of the magnetic cam 1006 pass by the magnet 1038 the magnetic coupling forces between the magnet 1038 and the magnetic cam 1006 are substantially directed towards applying a positive rotational force on the magnetic cam 1006 in the cam rotational direction D. In one example a net positive rotational force is applied directed substantially from the trailing end of the magnet 1038 (relative to rotation of the cam 1006) to portion P3 and at least a leading portion of section S4 as those regions of the cam 1006 rotate by the magnet 1038. In an example embodiment, as portion P3 and at least a leading portion of section S4 of the magnetic cam 1006 pass by the magnet 1038, the magnetic force field from the magnetic cam and the magnetic force field from the magnet 1038 are substantially directed towards each other so that force is efficiently applied to push the magnetic cam in the rotational direction D. In some example embodiments, the lever mounted magnets including magnet 1038 each may have a non-uniform magnetic field with the magnet field being greater at a trailing end of the magnet (relative to rotation of the cam 1006) than the leading end of the magnet. Such a non-uniform field can assist in some configurations in applying a positive rotational force on the magnetic cam.

As a result of the off-center mounting and asymmetrical magnetic field of cam 1006 and the pivoting nature of magnet 1038, it will be appreciated from the above description that as section S3 rotates by the magnet 1038, the magnetic forces between the cam 1006 and magnet 1038 are initially directed to apply a net anti-rotational force against the cam 1006, particularly as portion P1 rotates by the magnet 1038 and the lever 1028 is pushed to its activated position. As the cam 1006 continues to rotate, the direction of the magnetic force on the cam 1006 relative to the cam's rotational axis (drive shaft 1010) shifts—in particular, as portion P2 passes by the magnet 1038, the repulsive forces applied on cam 1006 are substantially directed in the direction of the drive shaft such that the anti-rotational forces and rotational forces are substantially balanced. As portion P3 passes by the magnet 1038 as well as section S4, the repulsive magnetic forces are directed to apply a net positive rotational force on the cam 1006.

In one example embodiment, due at least in part to the pivoting nature of the magnet 1038 and the asymmetrical configuration of the magnetic cam 1006, the anti-rotational forces applied against the magnetic cam 1006 by the magnetic coupling of magnet 1038 and cam 1006 as the lever 1028 is pivoted from its resting position to its activated position (i.e. when the magnet 1038 is in its second pivot position) is less than the positive rotational forces applied against the magnetic cam 1006 by the magnetic coupling of magnet 1038 and cam 1006 while the lever 1028 is in its activated position and the magnet 1038 is in its first pivot position.

In one example, the total rotational force or energy returned to the drive shaft 1010 as portion P3 of section 3 and section 4 of the cam 1006 pass by the magnet 1038 due to repulsive magnetic coupling forces is substantially equal to or just less than the total energy lost by the drive shaft 1010 as the magnetic cam 1006 forces the lever 1028 to its activated position as portion P1 passes by the magnet 1038. In some examples, the anti-rotational forces, relative to rotation direction D, applied by magnet 1038 against magnetic cam 1006 as portion P1 passes by the magnet 1038 are about equal to the positive rotational forces subsequently applied by magnet 1038 on magnetic cam 1006 relative to rotation direction D. In one example, magnetic coupling between the magnetic cam 1006 and the lever mounted magnet 1038 is such that energy consumed by drive shaft 1010 to push the lever 1028 from its resting position to its activated position is subsequently returned to the drive shaft 1010.

In FIG. 4, the levers 1090 and 1026 are each in their respective resting positions, levers 1028 and 1092 are each in an activated position, with the portion P3 of magnetic cam rotational section S3 passing by the magnetic field range of lever mounted magnet 1038.

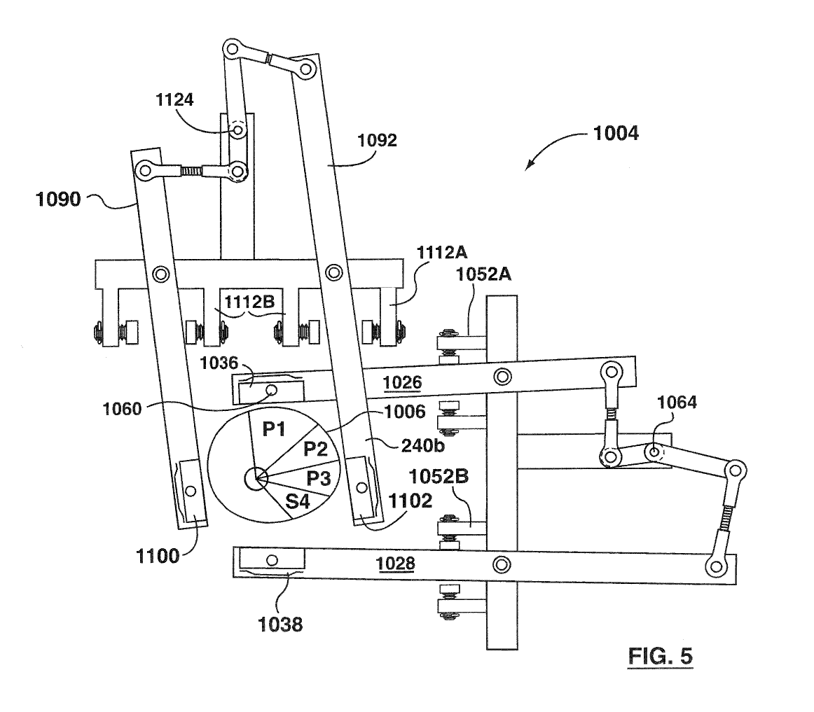

In FIG. 5, the right side vertically oriented lever 1092 has been fully repelled into its activated position with the lever mounted magnet 1102 located adjacent to and spaced apart from a largest radius portion of magnetic cam rotational section S3. In the fully activated position, the lever 1092 contacts its respective travel limiter 1112A to prevent any further outer pivoting of the lever 1092. As noted above in respect of lever 1028, the rotational sections S1-S4 also each successively pass by the magnet bearing end of lever 1092 during each rotation of the magnetic cam 1006. The magnetic cam 1006 interacts with the lever 1092 and magnet 1102 in substantially the same manner as described above in respect of the cam's 1006 interaction with lever 1028 and magnet 1038. Thus, during rotation of the magnetic cam 1006, there is a duration during which repulsive forces from the magnetic cam 1006 push the magnet bearing end of lever 1092 outwards away from the magnetic cam 1006, and a duration during which rotational energy is returned to the magnetic cam 1006. In FIG. 5, the levers 1028 and 1090 are each in their respective resting positions, lever 1026 and 1092 are in their activated positions, and the portion P3 of magnetic cam rotational section S3 is passing by the magnetic field range of lever mounted magnet 1102.

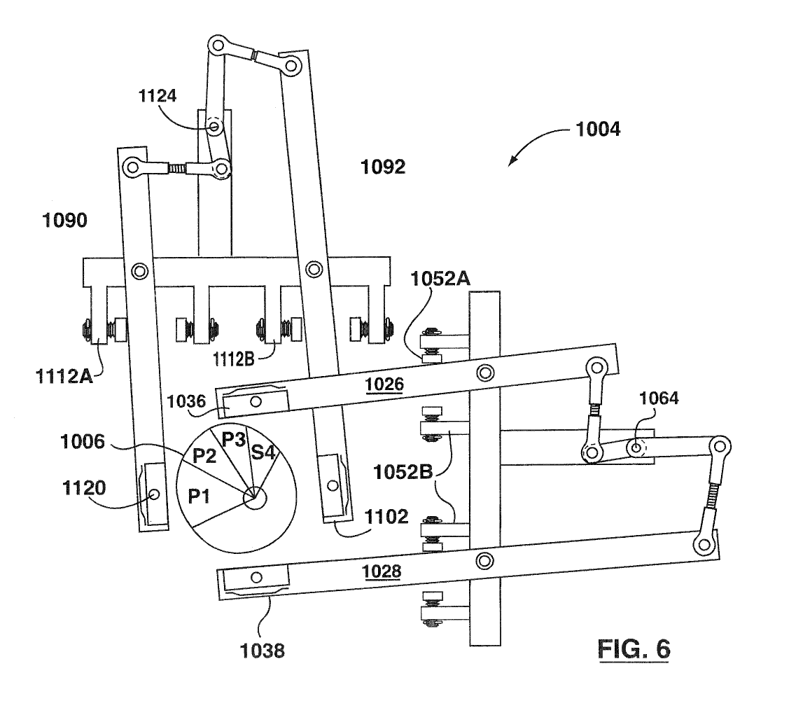

In FIG. 6, the top horizontally oriented lever 1026 has been fully repelled into its activated position with the lever mounted magnet 1036 located adjacent to and spaced apart from magnetic cam rotational section S3. In the fully activated position, the lever 1026 contacts its respective travel limiter 1052A to prevent any further outer pivoting of the lever 1026. As noted above in respect of lever 1028, the rotational sections S1-S4 also each successively pass by the magnet bearing end of lever 1026 during each rotation of the magnetic cam 1006. The magnetic cam 1006 interacts with the lever 1026 and magnet 1036 in substantially the same manner as described above in respect of the cam's 1006 interaction with lever 1028 and magnet 1038. Thus, during rotation of the magnetic cam 1006, there is aduration during which repulsive forces from the magnetic cam 1006 push the magnet bearing end of lever 1026 outwards away from the magnetic cam 1006 and a duration during which energy is returned to the magnetic cam 1006. In FIG. 6, the levers 1028 and 1092 are each in their respective resting positions and the levers 1026 and 1090 are in their activated position, with the portion P3 of magnetic cam rotational section S3 passing by the magnetic field range of lever mounted magnet 1036.

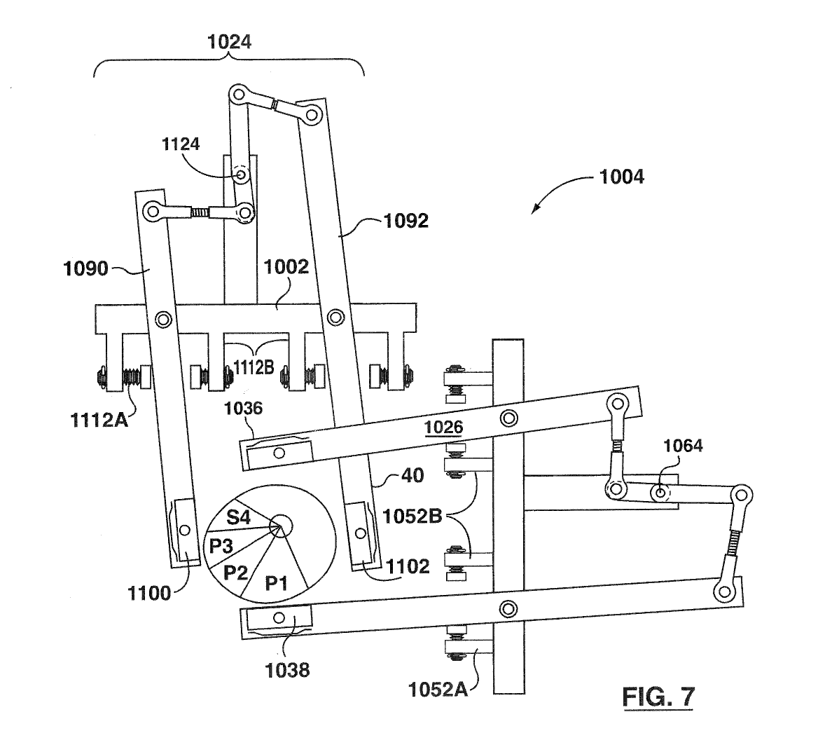

In FIG. 7, the left side vertically oriented lever 1090 has been fully repelled into its activated position with the lever mounted magnet 1100 located adjacent to and spaced apart from magnetic cam rotational section S3. In the fully activated position, the lever 1090 contacts its respective travel limiter 1112A to prevent any further outer pivoting of the lever 1090. As noted above in respect of lever 1028, the rotational sections S1-S4 also each successively pass by the magnet bearing end of lever 1090 during each rotation of the magnetic cam 1006. The magnetic cam 1006 interacts with the lever 1090 and magnet 1100 in the substantially the same manner as described above in respect of the cam's 1006 interaction with lever 1028 and magnet 1038. Thus, during rotation of the magnetic cam 1006, there is a duration during which repulsive forces from the magnetic cam 1006 push the magnet bearing end of lever 1090 outwards away from the magnetic cam 1006 and a duration during which energy is returned to the magnetic cam 1006. In FIG. 7, the levers 1026 and 1092 are each in their respective resting positions and the lever 1090 and 1028 are in their activated positions, with the portion P3 of magnetic cam rotational section S3 passing by the magnetic field range of lever mounted magnet 1100.

Accordingly, as the magnetic cam 1006 rotates it successively magnetically couples with the magnets mounted on levers 1028, 1092, 1026 and 1090 to successively and individually drive those levers into their activated states, which in turn results in first output shaft 1064 and second output shaft 1124 each being driven in a counterclockwise direction. The levers 1028, 1026, 1092 and 1090 are each biased to return to their resting position under the force applied by one or both of gravity or their respective biasing springs 1046, 1106, 1044 and 1104.

In at least some examples, energy used to displace the levers 1028, 1026, 1092 and 1090 to their active positions is returned to the drive shaft 1010 as the cam continues to rotate. Reference is made to FIGS. 13A through 13C and column (b) of table 1 to summarize the forces applied to magnetic cam 1006 as sections S3 and S4 of the cam 1006 rotate by a lever mounted magnet (magnet 1036 on lever 1026 in the illustrated example). As previously indicated, as result of the off-center mounting and asymmetrical magnetic field of cam 1006 relative to its rotational axis A, and the pivoting nature of the lever mounted magnet, as section S3 rotates by the magnet 1036, the magnetic forces between the cam 1006 and magnet 1036 are initially directed to apply a net anti-rotational force against the cam 1006, particularly as portion P1 rotates by the magnet 1036 and the lever 1026 is pushed to its activated position. In FIG. 13A, this net magnetic force is represented by line F, and as seen in FIG. 13A the force F is directed to a point to slightly to the right of rotational axis A, such that the Force F is working against rotation of the cam 1006 in rotational direction D. In FIG. 13A, Force F is directed slightly to the right of a straight reference line “L” that extends between the pin at the center of the drive magnet 1036 and the cam axis A. In Table 1, column (b), the “−” signs indicate a net negative rotational force being applied on the drive shaft 1010 as portion P1 of section S3 rotates by the lever mounted magnet. As the cam 1006 continues to rotate, the direction of the net magnetic force F on the cam 1006 relative to the cam's rotational axis (drive shaft 1010) shifts—in particular, as portion P2 passes by the magnet 1036, the net repulsive forces applied on cam 1006 are substantially directed towards the drive shaft 1010 such that the anti-rotational forces and rotational forces are substantially balanced in that they are substantially equal. In FIG. 13B, this net magnetic coupling force is represented by line F which is directed substantially at the axis of rotation A and aligned with reference line L. As portion P3 of Section S3 and Section S4 pass by the magnet 1036, the repulsive magnetic forces are directed to apply a net positive rotational force on the cam 1006, as indicated by arrow F which is directed to the left of axis A and reference line L in FIG. 13G. As will be appreciated from the above description, the cam at portion P3 of section S3 and section S4 is configured to be capable of providing a magnetic field that has a magnitude and direction sufficient enough to repel with the magnetic field from the magnetic block 1036 to push the cam 1006 forward in direction D to return the energy to the drive shaft. In at least some example embodiments the cam radius at portion P3 of section S3 and section S4 is reduced relative to portions P1 and P2, but the magnetic force at these areas is relatively strong due to the substantially increased thickness of the cam magnet. The thickness Tₘ of the cam magnet 1009 is large enough to provide a magnetic field strong enough to resulting in a repulsive force to push the cam in to rotate in the direction D. The approximate “L” shape of the cam magnet 1009 through section S4 allows the net magnetic coupling force F between the cam magnet 1009 and the magnet 1036 to be directed to the trailing end of the magnet 1036 to efficiently return the energy to the drive shaft.

In some example embodiments, the lever mounted magnets 1038, 1102, 1036 and 1100 are arranged relative to the cam 1006 such that at the same time that the magnetic coupling between the cam and one of the lever mounted magnets is applying an anti-rotational force on the cam, the magnetic coupling between another one of the lever mounted magnets and the cam is applying a positive rotational force on the cam. By way of example, in FIG. 4, magnetic coupling between magnet 1038 and cam 1006 is applying a positive rotational force on cam 1006 at the same time that magnetic coupling between magnet 1100 and cam 1006 is applying an-anti rotational force on cam 1006. Such a configuration may smooth out the forces applied on the cam 1006 as it rotates.

It will thus be appreciated that the radially asymmetrical profile of the magnetic field provided by magnetic cam 1006 provides a mechanism by which the levers 1028 and 1026 and levers 1090 and 1092 can be displaced by rotation of drive shaft 1010 to transfer rotational movement to output shafts 1064 and 1124, with assistive energy being subsequently returned to the drive shaft 1010.

In some examples the rotational energy returned to the drive shaft 1010 though positive rotational forces applied to the magnetic cam is about equal to the energy applied by the magnetic cam to displace the respective levers to their activated positions. Thus, in some example embodiments, where W1 is the power supplied to drive shaft 1010, R is resistance or friction loss registered by moving components of the torque multiplier 1000 and W2 is the resulting power or force output by the output shaft of the torque multiplier: W1+R<W2.

In at least some embodiments the power generator assembly 1004 efficiently provides and transfers torque from drive shaft 1010 to output shafts 1064 and 1124, with the resulting output torque being higher than the input torque. In some examples, the torque multiplier converts a small input torque to a larger output torque while maintaining the input to output speed ratio relativity consistent.

Accordingly, in example embodiments, the torque multiplier 1000 allows for an efficient transfer of torque from the power generator assemblies 1004A and 1004B to one or more output shafts. In example embodiments the output torque can have a different speed or torque force than the input torque depending, among other things, on the configuration of the output shafts and the output gears mounted thereon. In an example, the horizontally oriented levers 1026 and 1028 each are inclined at an angle to the horizontal when in the active position and the vertically oriented levers 1090, 1092 are also inclined at an angle relative to a vertical axis when in the active position, in order to facilitate return of rotational energy to the magnetic cam as it rotates. Such an angle could for example be between 3 degrees to 15 degrees in some examples, and 1 degree to 15 degrees in some examples.

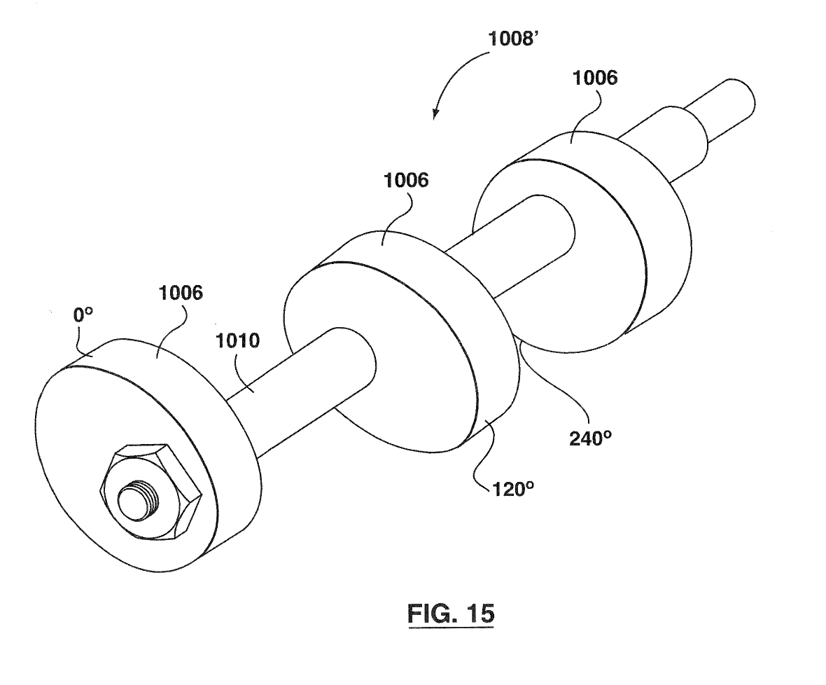

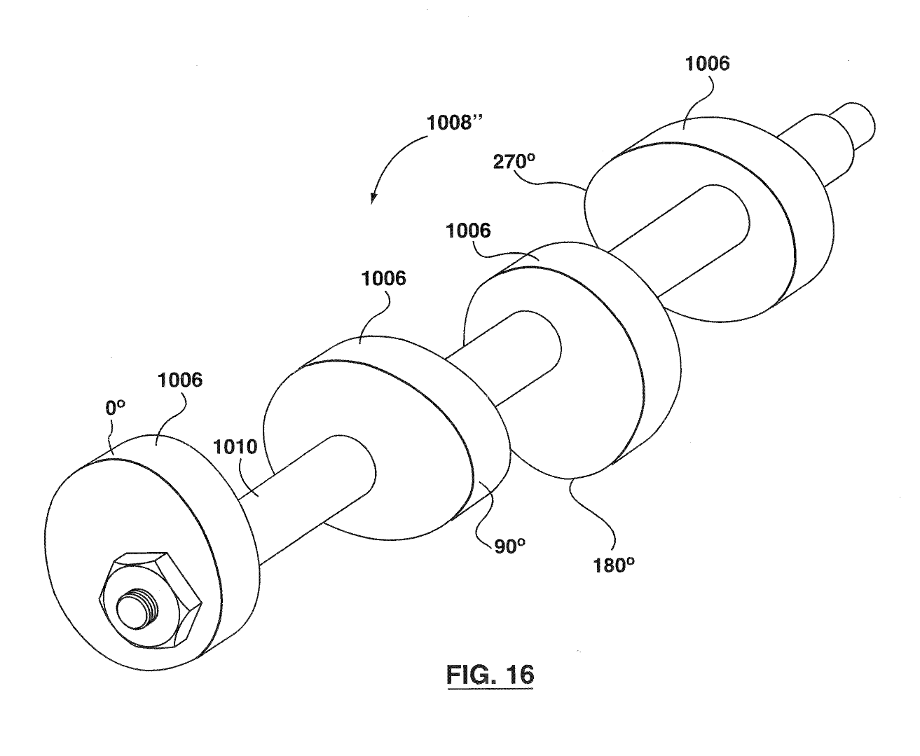

The operations described above in respect of power generator assembly 1004 occurs in each of power generator assemblies 1004A and 1004B, which share common drive shaft 1010 and first and second output shafts 1064, 1124. As noted above, in one example embodiment the magnetic cams 1006A and 1006B are 180 degrees out of phase, however other rotational displacement amounts could be used. In some example embodiments only a single power generator assembly 1004 may be present, and in some example embodiments more than two power generator assemblies 1004 may be present. By way of example, FIG. 15 illustrates an example of a drive assembly 1008′ that could be used in a torque multiplier that has three power generator assemblies 1004 and FIG. 16 illustrates an example of a drive assembly 1008″ that could be used in a torque multiplier that has four power generator assemblies 1004. The drive assembly 1008′ of FIG. 15 includes three magnetic cams 1006, with each magnetic cam sequentially located along the drive shaft 1010 rotationally trailing the previous magnetic cam by 120 degrees, and the drive assembly 1008″ of FIG. 16 includes four magnetic cams 1006, with each magnetic cam sequentially located along the drive shaft 1010 rotationally trailing the previous magnetic cam by 90 degrees.

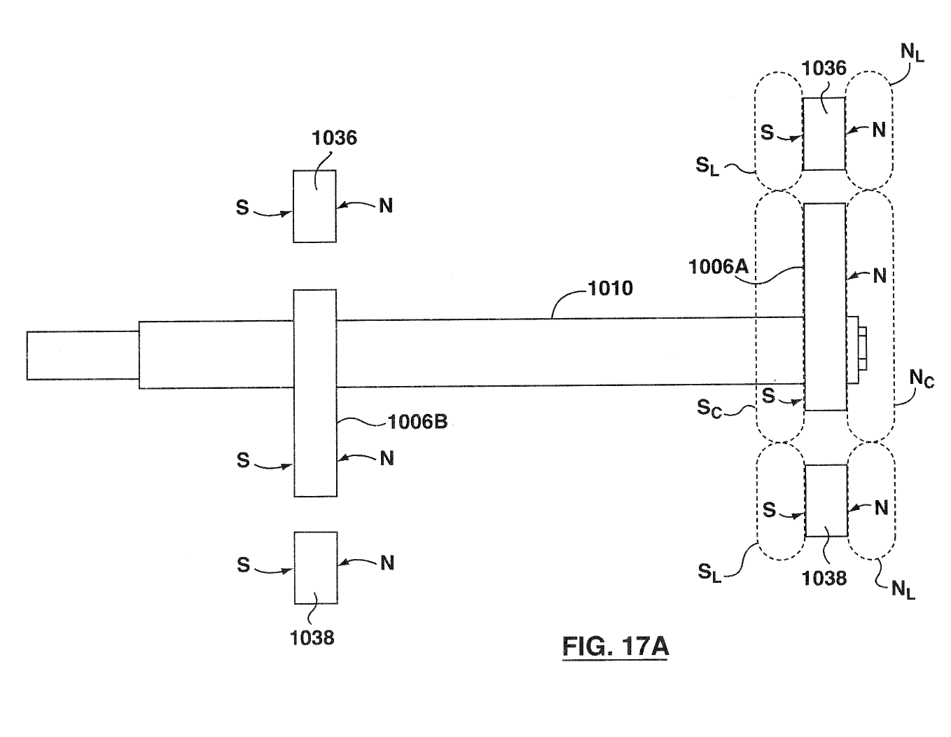

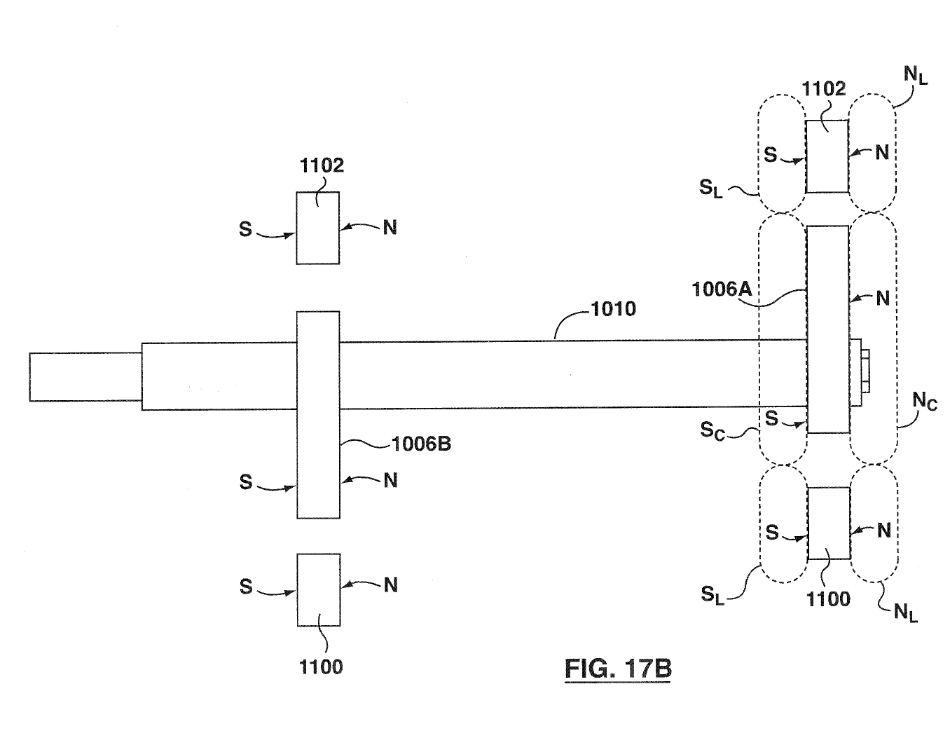

The relative location and magnetic field position of the magnetic cams 1006 and the lever mounted magnets 1038, 1036, 1100, 1102 can be different in different embodiments and achieve repulsive magnetic coupling in the manner described above. By way of example, FIGS. 17A and 17B illustrate an alternative embodiment in which the magnetic cams 1006A and 1006B are each permanent magnets having opposite facing planar sides located in a plane perpendicular to their axis of rotation, with one side being the magnetic north pole and the other side being the magnetic south pole. The letters “N” and “S” are used in FIGS. 17A and 17B to denote the north pole and south pole sides, respectively, of the magnetic cams 1006A and 1006B. In the illustrated embodiments the two magnetic cams 1006A and 1006B are both oriented with their respective north pole sides facing the same direction. In such an example, the magnetic orientation of the lever-mounted magnets 1036, 1038 is the same as that of their associated magnetic cams 1006A, 1006B. In particular, in the illustrated configuration of FIGS. 17A and 17B, the north poles of each of the lever-mounted magnets 1036, 1038 face the same direction as the north poles of the magnetic cams 1006A, 1006B, and the south poles of each of the lever-mounted magnets 1036, 1038 face the same direction as the south poles of the magnetic cams 1006A, 1006B. In such a configuration, the north magnetic fields (illustrated by dashed line N_{L}) produced by the lever mounted magnets 1036 and 1038 are vertically aligned with the north magnetic field (illustrated by dashed line N_{C}) produced by their associated magnetic cams 1006A, 1006B, and the south magnetic fields (illustrated by dashed line S_{L}) produced by the lever mounted magnets 1036 and 1038 are vertically aligned with the south magnetic field (illustrated by dashed line S_{C}) produced by their associated magnetic cams 1006A, 1006B. Such a magnetic orientation of the lever-mounted magnets 1036, 1038 and the magnetic cam 1006 results in the magnetic cam 1006 applying repulsive forces on the lever-mounted magnets 1036, 1038. The asymmetrical configuration of magnetic cam 1006 is such that the magnitude of the repulsive magnetic forces applied by the magnetic cam 1006 on the lever-mounted magnets 1036, 1038 varies as the magnetic cam rotates, which is used to reciprocate the first and second levers 1026 and 1028 between their respective resting states and their respective activated states in the same manner as described above.

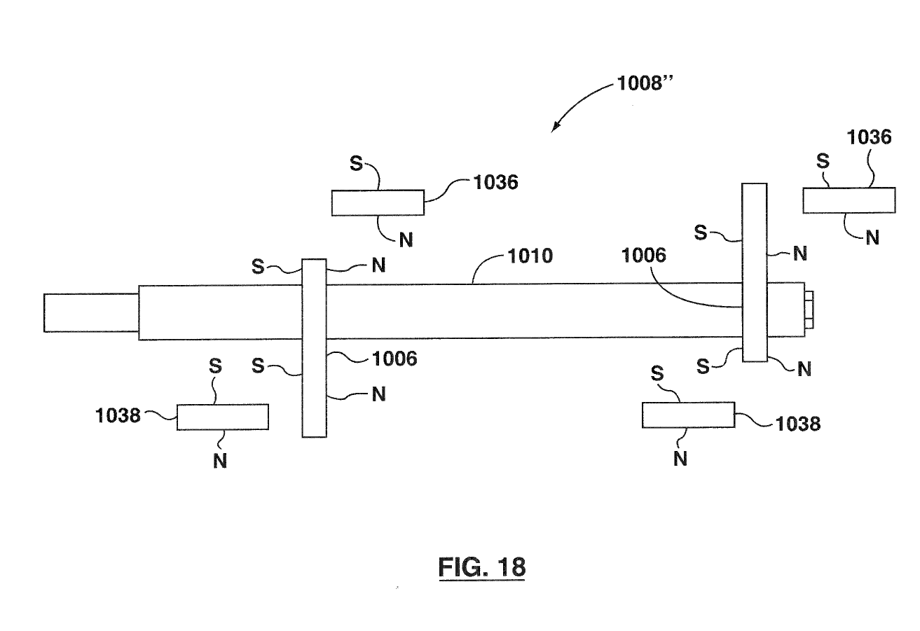

FIG. 18 illustrates a further alternative configuration of lever mounted magnets 1038, 1036 relative to magnetic cams 1006. In the embodiment of FIG. 18, lever mounted magnet 1038 is positioned to one side of the magnetic cam 2006 with its south pole facing the drive shaft 1010 and perpendicular to the south pole of the magnetic cam 1006. Lever mounted magnet 1036 is positioned to the other side of the magnetic cam 2006 with its north pole facing the drive shaft 1010 and perpendicular to the north pole of the magnetic cam 1006. In the embodiment of FIG. 18, the levers 1090, 1092, 1026 and 1028 can be configured to pivot in directions parallel to the axis of drive shaft 1010 rather than in directions perpendicular to the axis of drive shaft 1010 as described above.

Magnetic cam 1006 could take different configurations than shown and still provide a similar magnetic field profile. For example, a circular disk with a least two magnets asymmetrically placed about its perimeter and with an off-center axis of rotation could be used to implement magnetic cam 1006. Similarly, an asymmetric nonmagnetic cam with magnets placed about its perimeter could be used to implement magnetic cam 1006. In some example embodiments electromagnets could be used in place of one or more of the permanent magnets described above. In some example embodiments, forces of magnetic attraction rather than magnetic repulse could provide the magnetic coupling needed between magnetic cam 1006 and one or more of the levers to drive the output shafts. Although in the embodiments described above the levers drive their respective output shafts when moved from a resting or home position to an active position, the mechanical linkages 1126, 1128, 1066, 1068 could alternatively be configured to drive the respective output shafts when moving from the active position to the resting or home position. Furthermore the mechanical linkages and magnets could be located at other positions on the levers in alternative embodiments such that second or third class levers are implemented as opposed to the first class levers shown in the figures.

Although each power generator assembly 1004 has been described as having four magnet carrying levers 1026, 1028, 1090, 1092, more or fewer than four levers could be included in each power generator assembly in different example embodiments.

As noted above, the magnetic cam 1006 can take different forms and shapes. In some example embodiments, the magnetic cam 1006 could be configured such that the magnetic profile provided by sections S1, S2, S3 and S4 were serially repeated multiple times about the circumference of the cam 1006. In such a configuration, the each lever would move between its active and resting positions multiple times during each rotation of the magnetic cam. Additionally, in some embodiments, the cam sections S1 and S2 could be eliminated from the cam such that Sections S3 and S4 were adjacent each other at both the start and ends thereof without any intervening sections 51 and S2.

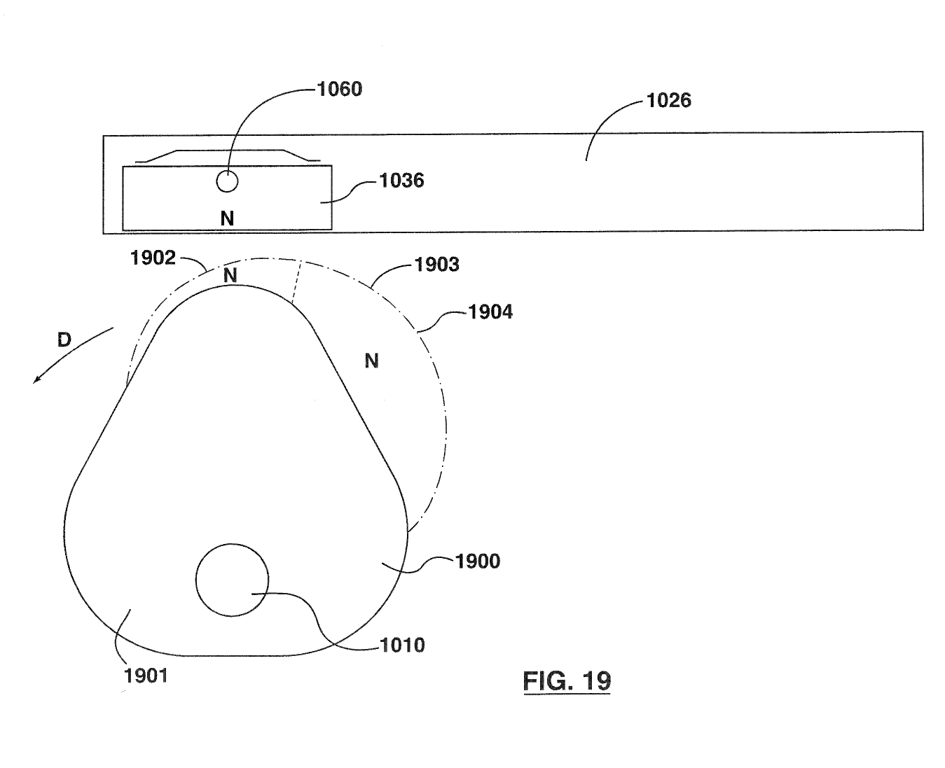

FIG. 19 illustrates a partial view of a further example embodiment of torque multiplier 1000 showing only the end of one of the levers 1026. The torque multiplier of FIG. 19 is similar to the torque multiplier embodiments described above, except that the magnetic cam 1006 has been replaced with a triangular shaped magnetic cam 1900. In an example, magnetic cam 1900 includes a triangular body 1901 that is mounted off-center on drive shaft 1010 to rotate in counterclockwise direction D. One or more permanent magnets are integrated into or mounted onto the triangular body 1901 to provide a radially asymmetrical magnetic field relative to drive shaft 1010 represented by dashed line 1903 in FIG. 19. In one example, the magnetic field represented by dashed 1903 is a north pole magnetic field and has two sections, namely first magnetic section 1902 facing out from one side edge and second magnetic section 1904 facing out from an adjacent side edge such that first magnetic section 1902 rotates by lever mounted magnet 1036 followed by second magnetic section 1904 section during each rotation of the magnetic cam 1900, with the transition from first magnetic section 1902 to second magnetic section 1904 occurring near a corner of the triangle. In the illustrated embodiment, first magnetic section 1902 is weaker than second magnetic section 1904 as illustrated by line 1903.

In one example, the lever 1026 is pushed out to its activated position as the weaker first magnetic section 1902 rotates past the lever mounted magnet 1036, and remains in its activated position until after the stronger second magnetic section 1904 finishes rotating by the lever mounted magnet 1036. As the first magnet section 1902 passes by the magnet 1036, negative rotational force (e.g. against rotational direction D) is applied against the triangular cam 1900 by magnet 1036. However, after the corner transition, between first magnetic section 1902 and magnetic section 2 passes by the lever mounted magnet 1036, the magnetic repulsive forces between the second magnetic section 1904 and the lever mounted magnet 1036 are directed to apply positive rotational force (e.g. in rotational direction D) against the triangular cam 1900.

In an example embodiment, the anti-rotational force on cam 1900 due to repulsive magnetic forces between the lever mounted magnet 1036 and the first magnetic section 1902 are about equal to the positive rotational force on cam 1900 due to the repulsive magnetic forces between the lever mounted magnet 1036 and the second magnetic section 1904 such that the energy expended as the lever 1026 is pushed to its activated state is subsequently returned to the drive shaft 1010 by the positive rotational force applied on the cam 1900 as second magnet 1904 rotates by the lever mounted magnet 1036.

It will thus be appreciated that the results described herein can be achieved with different magnetic cam configurations in which the magnetic field of the cam is asymmetrical or varies relative to the rotational axis of the cam.

In the above described embodiments the magnet support members that support the drive magnets 1036, 1038, 1100, 1102 take the form of levers 1026, 1028, 1090 and 1092, respectively, that a linked by mechanical linkages to drive output shafts 1064, 1124. In alternative embodiments, drive magnets 1036, 1038, 1100, 1102 may be mounted on magnet support members that take a form other than levers and which are connected by other forms of mechanical linkages to drive output shafts 1064, 1124. By way of example, using drive magnet 1036 for illustrative purposes, the drive magnet 1036 could be mounted to a sliding mechanism that moves up and down to permit the magnet 1036 to reciprocate between the active and resting positions in response to changes in the magnetic coupling forces as magnetic cam 1006 rotates by it. The sliding mechanism could include an indexing arm to drive an indexed wheel each time the drive magnet 1036 is repulsed to its activated position, thereby converting the motion of the drive magnet 1036 into a rotational output motion for driving an output shaft 1064. The drive magnet 1036 may, in some configurations, be pivotally mounted to the sliding mechanism to pivot between its first pivot position and second pivot position relative to the sliding mechanism at various times during the rotation of the cam 1006. Thus, a circular indexing system can be employed to mechanically link the drive magnet 1036 to an output shaft. Various other mechanical linkages can alternatively be employed that convert movement of the drive magnet 1036 between its activated and resting positions into rotational movement of an output shaft.

The present disclosure may be embodied in other specific forms without departing from its spirit or essential characteristics. The described embodiments are to be considered in all respects as being only illustrative and not restrictive. The present disclosure intends to cover and embrace all suitable changes in technology. The scope of the present disclosure is, therefore, described by the appended claims rather than by the foregoing description. All changes that come within the meaning and range of equivalency of the claims are intended to be embraced within their scope.

1. A torque multiplier for converting an input torque to an output torque, comprising:
a drive shaft having a cam mounted thereon, the cam providing a magnetic field that is radially asymmetrical relative to the drive shaft;
a first output shaft for providing an output torque; and
a first lever mounted to pivot between a first position and a second position and bearing a lever-mounted magnet spaced apart from the cam, the first lever is biased towards the first position; and
a travel limiter that impedes the first lever from pivoting beyond the second position when the first lever pivots to the second position, the first lever being operatively connected to rotationally drive the first output shaft, wherein magnetic coupling between the cam and the lever-mounted magnet during rotation of the cam causes the first lever to pivot and a part of rotational energy to subsequently be returned to the drive shaft.

2. The torque multiplier of claim 1 wherein the first lever pivots from the first position to the second position and back to the first position at least once during each rotation of the cam.

3. The torque multiplier of claim 2 wherein the cam has a first part and a second part that each rotate by the lever-mounted magnet at respective times during the rotation of the cam, wherein the first lever pivots from the first position to the second position as the first part passes by the lever-mounted magnet, and wherein magnetic coupling between the cam and the lever-mounted magnet when the second part passes by the lever-mounted magnet pushes the cam to return part of the rotational energy to the drive shaft.

4. The torque multiplier of claim 3 wherein a radial distance from the drive shaft to an outer surface of the cam varies about an outer perimeter of the cam, and a strength of the magnetic field varies about the outer perimeter of the magnetic cam.

5. The torque multiplier of claim 4 wherein the radial distance is greater at the first part than the second part and the strength of the magnetic field is greater at the second part than the first part.

6. The torque multiplier of claim 3, 4 or 5 wherein the lever-mounted magnet is pivotally mounted to the lever to pivot between a first magnet position and a second magnet position due to magnetic coupling with the cam as the cam rotates, wherein the lever-mounted magnet is in the second magnet position for at least some of a time that the first lever pivots from the first position to the second position, and the lever-mounted magnet is in the first magnet position for at least some of a time that part of the rotational energy is returned to the drive shaft, wherein when the lever-mounted magnet is in the first magnet position pivoting of the lever-mounted magnet in a direction opposite to a rotational direction of the cam is prevented.

7. The torque multiplier of claim 6 wherein the lever-mounted magnet pivots from the first magnet position to the second magnet position just prior to the first lever pivoting away from the first position and the lever-mounted magnet pivots back from the second magnet position to the first magnet position before the first lever reaches the second position.

8. The torque multiplier of claim 7 wherein the lever mounted magnetic is biased towards the first magnet position, and part of the rotational energy is returned to the drive shaft during at least part of a time that the first lever is in the second position and the lever mounted magnet is in the first magnet position.

9. The torque multiplier of claim 8 wherein positive rotational forces applied against the cam by the magnetic coupling of the lever-mounted magnet and the cam while the first lever is in its second position is slightly less than or substantially equal to anti-rotational forces applied against the cam by magnetic coupling of the lever-mounted magnet and the cam as the first lever is pivoted from the first position to the second position.

10. The torque multiplier of any one of claims 1, 6 to 9 wherein the magnetic coupling is a repulsive force between the cam and the lever-mounted magnet.

11. The torque multiplier of any one of claims 1, 6 to 10 wherein the cam comprises a permanent magnet that is mounted off center having an outer radius that varies about an outer perimeter thereof with respect to a rotational axis of the drive shaft.

12. The torque multiplier of any one of claims 1, 6 to 10 wherein the cam comprises a triangular member having providing the magnetic field that varies about an outer perimeter thereof.

13. The torque multiplier of any one of claims 1, 6 to 12 wherein the first lever is operatively connected to the first output shaft by a mechanical linkage that translates movement of the first lever into a rotational force on the first output shaft.

14. The torque multiplier of any one of claims 1, 6 to 13 further comprising:
at least a second lever biased into a first position and bearing a second lever-mounted magnet spaced apart from the cam, the further lever being operatively connected to rotationally drive the first output shaft, wherein magnetic coupling between the cam and the second magnet during each rotation of the cam causes the second lever to pivot and part of the rotational energy to subsequently be returned to the drive shaft.

15. The torque multiplier of claim 14 further comprising:
a second output shaft;
a third lever biased into a first position and bearing a third magnet spaced apart from the cam, the third lever being operatively connected to rotationally drive the second output shaft, wherein magnetic coupling between the cam and the third magnet during each rotation of the cam causes the third lever to pivot and part of rotational energy to subsequently be returned to the drive shaft; and
a fourth lever biased into a first position and bearing a fourth magnet spaced apart from the cam, the fourth lever being operatively connected to rotationally drive the second output shaft, wherein magnetic coupling between the cam and the fourth magnet during each rotation of the cam causes the fourth lever to pivot and part of the rotational energy to subsequently be returned to the drive shaft,
wherein the first output shaft and the second output shaft are mechanically coupled to collectively drive a third output shaft.

16. The torque multiplier of any one of claims 1, 2 to 15 comprising:
multiple cams mounted at spaced apart locations on the drive shaft, the cams each providing a respective magnetic field that is radially asymmetrical relative to the drive shaft; and
for each of the multiple cams, a first lever mounted to pivot between a first position and a second position and bearing a lever-mounted magnet spaced apart from the cam, the first lever being operatively connected to rotationally drive the first output shaft, wherein magnetic coupling between the cam and the lever-mounted magnet during each rotation of the cam causes the first lever to pivot and part of the rotational energy to subsequently be returned to the drive shaft.

17. The torque multiplier of claim 16 wherein the multiple cams are out of rotational phase with each other.

18. A torque multiplier for converting an input torque to an output torque, comprising:
a frame;
an input drive assembly including a drive shaft rotatably mounted to the frame and a magnetic cam mounted for rotation with the drive shaft, the magnetic cam providing a magnetic field that varies in strength about a circumference of the drive shaft;
a first output shaft rotatably mounted to the frame; and
a first lever mounted to the frame for pivoting between a resting position and an activated position, the first lever bearing a first magnet pivotally mounted at one end of the first lever for pivoting between a first magnet position and a second magnet position wherein the first magnet pivots in the same rotational direction as the magnetic cam when pivoting from the first magnet position to the second magnet position, the first lever connected at an opposite end thereof by a mechanical linkage to rotationally drive the first output shaft when the first lever is moved from the resting position to the activated position, the magnet bearing end of the first lever being located adjacent the magnetic cam, the first lever being normally biased into the resting position,
wherein during rotation of the magnetic cam changes in repulsive magnetic forces between the magnetic cam and the first magnet cause: (a) the first magnet to pivot from the first magnet position to the second magnet position; (b) the first lever to pivot from the resting position to the activated position; (c) the first magnet to pivot from the second magnet position back to the first magnet position while the first lever moves from the resting position to the activated position, and (d) the first lever to return to the resting position.

19. The torque multiplier of claim 18 wherein positive rotational energy is returned to the drive shaft during at least a portion of the duration during which the first lever is in the activated position.

20. The torque multiplier of claim 19 comprising travel limiting members coupled to the frame for preventing the first lever from pivoting outside a range defined by the activated position and the resting position and a limiting device coupled to the first lever for preventing the first magnet from pivoting outside of a range defined by the first magnet position and the second magnet position.

21. The torque multiplier of claim 20 wherein the limiting device biases the first magnet towards the first magnet position.

22. The torque multiplier of any one of claims 18 to 21 wherein during at least a part of a duration when positive rotational energy is returned to the drive shaft, magnetic coupling forces between the magnetic cam and the first magnet are substantially directed at a trailing end of the first magnet relative to a rotational direction of the magnetic cam.

23. The torque multiplier of any one of claims 18 to 22 wherein when the first magnet is in the second magnet position, force applied on the first magnet by magnetic coupling with the cam is substantially directed to a center of the first magnet to apply force to move the first lever from the resting position to the activated position.

24. A torque multiplier for multiplying an input torque to a larger output torque, comprising:
a first magnetic cam rotatable about a first axis and providing a magnetic field that is radially asymmetrical relative to the first axis;
a first output shaft; and
a first lever biased into a first position and bearing a first magnet spaced apart from the first magnetic cam, wherein the first magnet is pivotally mounted to the lever, the first lever being operatively connected to rotationally drive the first output shaft, wherein magnetic coupling between the first magnetic cam and the first magnet causes the first lever to pivot from the first position to a second position during rotation of the first magnetic cam.

25. A torque multiplier for multiplying an input torque to a larger output torque, comprising:
a frame;
an input drive assembly including a drive shaft rotatably mounted to the frame and a magnetic cam mounted for rotation with the drive shaft, the magnetic cam providing a magnetic field that varies in strength around a circumference of the drive shaft;
a first output shaft rotatably mounted to the frame; and
a magnet pivotally mounted to the frame for movement between a resting position and an activated position, the magnet being connected by a mechanical linkage to rotationally drive the first output shaft when the magnet is moved from the resting position to the activated position;
a travel limiter that impedes the magnet from pivoting beyond a set position,
the magnet being located adjacent the magnetic cam such that repulsive magnetic forces between the magnetic cam and the magnet cause the magnet to move from the resting position to the activated position and subsequently return to the resting position during rotation of the cam.

26. The torque multiplier of claim 25 wherein at least once during each rotation of the magnetic cam, repulsive magnetic forces between the magnet and the magnetic cam returns positive rotational energy to the drive shaft.

27. A torque multiplier for converting an input torque to an output torque, comprising:
a cam mounted on a drive shaft for rotation therewith when an input torque is applied to the drive shaft, the cam providing a magnetic field that is radially asymmetrical relative to the drive shaft;
a first output shaft for providing an output torque;
a magnet spaced apart from the cam and pivotally mounted to move relative to the cam in response to magnetic coupling forces between the cam and the magnet as the cam rotates, and
a travel limiter that impedes the magnet from pivoting beyond a set position, the magnet being operatively connected to drive the first output shaft, wherein magnetic coupling forces between the cam and the magnet return part of rotational energy to the drive shaft during part of the cam rotation.

28. The torque multiplier of claim 27 wherein a radial distance from the drive shaft to an outer surface of the cam varies about an outer perimeter of the cam, and a strength of the magnetic field varies about the outer perimeter of the magnetic cam.

29. The torque multiplier of claim 28 wherein the cam includes a first peripheral portion, a second peripheral portion and a third peripheral portion that rotate successively by the magnet during each cam rotation, wherein the radial distance is greater at the first peripheral portion than the third peripheral portion, the strength of the magnetic field is greater at the third peripheral portion than the first peripheral portion, and the strength of the magnetic field and the radial distance each are substantially constant across the second peripheral portion.

30. The torque multiplier of claim 29 wherein the magnet is moved from a resting position to an activated position as the first peripheral portion rotates thereby and the magnet remains in the activated position as the second and third peripheral portions rotate thereby, and magnetic coupling forces between the cam and the magnet return part of the rotational energy to the drive shaft as the third peripheral portion of the cam rotates by the magnet, wherein the magnet moves back to its resting position subsequent to at least part of the third portion rotating thereby.

31. The torque multiplier of claim 30 wherein the magnetic coupling forces are repulsive forces, the magnet is mounted to move substantially radially away from drive shaft when moving from the resting position to the activated position, and the magnet is biased towards the resting position.

32. The torque multiplier of claim 31 wherein the magnet is mounted to pivot between first and second pivot positions in addition to moving between the resting and activating positions, wherein the magnet pivots from its first pivot position to its second pivot position and back to its first pivot position as the first peripheral portion rotates thereby.

33. The torque multiplier of claim 27 comprising a second magnet spaced apart from the cam and mounted to move relative to the cam in response to magnetic coupling forces between the cam and the second magnet as the cam rotates, the second magnet being operatively connected to drive an output shaft, wherein magnetic coupling forces between the cam and the second magnet returns part of the rotational energy to the drive shaft during part of the cam rotation that is different than the part of the cam rotation when magnetic coupling forces between the cam and the magnet returns part of the rotational energy to the drive shaft.

34. The torque multiplier of claim 33 wherein magnetic coupling forces between the cam and the second magnet returns part of the rotational energy to the drive shaft during a time when magnetic coupling forces between the cam and the magnet draws energy from the drive shaft.

35. A torque multiplier for multiplying an input torque to a larger output torque, comprising:
a frame;
an input drive assembly including a drive shaft rotatably mounted to the frame and one or more magnetic cams mounted for rotation with the drive shaft, each of the magnetic cams providing a magnetic field that varies in strength around a circumference of the drive shaft;
a first output shaft rotatably mounted to the frame;
one more levers, each lever mounted to the frame to pivot between a resting position and an activated position;
one or more magnets, each pivotally mounted to one of the levers, hereinafter “lever-mounted magnets”, each of the lever-mounted magnets being connected by a mechanical linkage to rotationally drive the first output shaft when each of the lever-mounted magnets is moved in turn from the resting position to the activated position,
one or more travel limiters provided on the frame each impeding one of the levers from pivoting beyond a maximum pivot limit,
each of the lever-mounted magnets being located adjacent the one or more magnetic cams such that repulsive magnetic forces between the one or more magnetic cams and each of the lever-mounted magnets cause the one or more lever-mounted magnets to move from the resting position to the activated position and subsequently return to the resting position during rotation of the one or more cams.

36. The torque multiplier of claim 35, wherein each of the lever-mounted magnets is further pivotally mounted to pivot between a first pivot position and a second pivot position, wherein during the rotation of the one or more cams, as a lever-mounted magnet pivots from the first pivot position to the second pivot position, energy from a respective magnetic cam is transferred to the first output shaft, and as the lever-mounted magnet pivots back from the second pivot position to the first pivot position at least part of the energy is returned to the drive shaft, while part of the energy is transferred to the leaf spring, as the cam continues to rotate the energy from the leaf spring is injected back to the cam.

37. The torque multiplier of claim 35, wherein each of the one or more travel limiters is adjustable and each travel limiter comprises a stop member for contacting the one or more levers.

38. The torque multiplier of claim 35, wherein one or more travel limiters sets the maximum pivot limit of each respective lever when one or more of the lever-mounted magnets is in the activated position by contacting the respective lever to prevent further pivoting.

39. The torque multiplier of claim 35, wherein one or more travel limiters sets the maximum pivot limit of each respective lever when one or more of the lever-mounted magnets is in the resting position by contacting the respective lever to prevent further pivoting.
